(19) United States
(12) Patent Application Publication
(10) Pub. No.: US 2014/0254687 A1
(43) Pub. Date: Sep. 11, 2014

(54) ENCODING DEVICE AND ENCODING METHOD, AND DECODING DEVICE AND DECODING METHOD

(71) Applicant: SONY CORPORATION, Minato-ku, Tokyo (JP)

(72) Inventor: Kenji Kondo, Tokyo (JP)

(73) Assignee: SONY CORPORATION, Minato-ku, Tokyo (JP)

(21) Appl. No.: 14/346,833

(22) PCT Filed: Oct. 25, 2012
(86) PCT No.: PCT/JP12/77583

§ 371 Date: Mar. 24, 2014

(30) Foreign Application Priority Data
Nov. 4, 2011 (JP) 2011-242150

(51) Int. Cl. H04N 19/61; H04N 19/51

(52) U.S. Cl. CPC H04N 19/00781; H04N 19/00684
USPC 375/240.16

(57) ABSTRACT

The present technique relates to an encoding device and an encoding method, and a decoding device and a decoding method that can improve encoding efficiency when a motion compensation operation with fractional precision is performed upon inter prediction. When the precision of a motion vector is ¼-pixel precision and the precision of a predicted vector is ⅛-pixel precision according to detected-precision information contained in compressed image information, a predicted-vector transform unit performs a rounding operation on the predicted vector to generate a predicted vector with ¼-pixel precision. A motion vector generation unit adds the predicted vector with ¼-pixel precision to a difference vector contained in the compressed image information, to generate a motion vector. An inter prediction unit and an arithmetic operation unit decode an image by performing a motion compensation operation using the motion vector. The present technique can be applied to a decoding device, for example.

### TECHNICAL FIELD

The present technique relates to an encoding device and an encoding method, and a decoding device and a decoding method, and more particularly to an encoding device and an encoding method, and a decoding device and a decoding method that can improve encoding efficiency when a motion compensation operation with fractional precision is performed upon inter prediction.

### BACKGROUND ART

As a standard for image compression, there is H.264/MPEG (Moving Picture Experts Group)-4 Part10 Advanced Video Coding (hereinafter referred to as H.264/AVC).

According to H.264/AVC, inter predictions are performed by taking advantage of correlations between frames or fields. In an inter prediction, a motion compensation operation is performed using a partial region in an encoded image, to generate a predicted image.

In recent years, it has been considered to increase the precision of the motion compensation operation by improving the resolution of a motion vector to fractional precision such as one-half or one-quarter in the motion compensation operation.

In a motion compensation operation with fractional precision, the operation of setting a virtual pixel in a fractional position, called a sub-pel, between adjacent pixels in a reference image and generating the sub-pel (hereinafter referred to as interpolation) is additionally performed (see Non-Patent Document 1, for example). That is, in a motion compensation operation with fractional precision, the lowest motion vector resolution is a fractional multiple of the number of pixels, and therefore, interpolations to generate pixels in fractional positions are performed.

Interpolation filters (IF) used in interpolations are normally finite impulse response (FIR) filters.

When the precision of the motion compensation operation is improved in the above described manner, the quality of a predicted image improves. However, the amount of the improvement generally decreases as the precision of the motion compensation operation increases. In addition, motion vectors are transmitted contained in an encoded stream. Thus, if the precision of motion vectors are improved too much, even if the quality of a predicted image is improved, the amount of information on the motion vectors increases more than the amount of the improvement, degrading encoding efficiency.

### CITATION LIST

### Non-Patent Document

Non-Patent Document 1: Joint Collaborative Team on Video Coding (JCT-VC) of ITU-T SG16 WP3 and ISO/IEC JTC1/SC29/WG11 6th Meeting, Working Draft 4 of High-Efficiency Video Coding, JCTVC-F803_d2, Torino, IT, 14-22 Jul., 2011

### SUMMARY OF THE INVENTION

### Problems to be Solved by the Invention

Meanwhile, when the prediction direction of a motion vector is bidirectional, the number of motion vectors per prediction block is doubled compared to when the prediction direction is unidirectional. In addition, when the block size of a prediction block is small, the number of motion vectors per picture is large compared to when the block size is large.

As such, when the number of motion vectors to be transmitted is large, even if the precision of a predicted image is improved by the improvement in the precision of the motion compensation operation, encoding efficiency may not be improved due to the increase in the amount of information on the motion vectors.

The present technique is made in view of such circumstances, and is to enable to improve encoding efficiency when a motion compensation operation with fractional precision is performed upon inter prediction.

### Solutions to Problems

A decoding device of a first aspect of the present technique includes:

a reception unit that receives an encoded image, a difference between a motion vector of the image in an inter prediction and a predicted vector, and detected-precision information indicating that precision of the motion vector for when a prediction direction of the inter prediction is bidirectional is lower than precision of the motion vector for when the prediction direction is unidirectional, the predicted vector being a motion vector of an image located close to the image; a predicted-vector transform unit that performs, when the precision of the motion vector is lower than the predetermined precision and the precision of the predicted vector is the predetermined precision according to the detected-precision information received by the reception unit, a rounding operation on the predicted vector to generate a predicted vector with a lower precision than the predetermined precision;

a motion vector generation unit that adds the predicted vector with a lower precision than the predetermined precision generated by the predicted-vector transform unit to the difference received by the reception unit, to generate a motion vector; and a decoding unit that decodes the image by performing a motion compensation operation using the motion vector generated by the motion vector generation unit.

A decoding method of the first aspect of the present technique is compatible with the decoding device of the first aspect of the present technique.

In the first aspect of the present technique, an encoded image, a difference between a motion vector of the image in an inter prediction and a predicted vector, and detected-precision information indicating that precision of the motion vector for when a prediction direction of the inter prediction is bidirectional is lower than precision of the motion vector for when the prediction direction is unidirectional are received, the predicted vector being a motion vector of an image located close to the image; when the precision of the motion vector is lower than the predetermined precision and the precision of the predicted vector is the predetermined precision according to the detected-precision information, a rounding operation is performed on the predicted vector to generate a predicted vector with a lower precision than the predetermined precision; the predicted vector with a lower precision than the predetermined precision is added to the difference to generate a motion vector; and the image is decoded by performing a motion compensation operation using the motion vector.

An encoding device of a second aspect of the present technique includes: a high-precision motion detection unit that detects, with a predetermined precision, when a prediction direction of an inter prediction of an encoding target image is unidirectional, the motion vector of a reference image for the encoding target image in the inter prediction, using the encoding target image and the reference image for the encoding target image; a low-precision motion detection unit that detects, with a lower precision than the predetermined precision, the motion vector using the encoding target image and the reference image, when the prediction direction is bidirectional; an encoding unit that encodes the encoding target image by performing a motion compensation operation using the motion vector detected by the high-precision motion detection unit or the low-precision motion detection unit; and a transmission unit that transmits the encoding target image encoded by the encoding unit, and the motion vector.

An encoding method of the second aspect of the present technique is compatible with the encoding device of the second aspect of the present technique.

In the second aspect of the present technique, when a prediction direction of an inter prediction of an encoding target image is unidirectional, the motion vector of a reference image for the encoding target image in the inter prediction is detected with a predetermined precision, using the encoding target image and the reference image for the encoding target image; when the prediction direction is bidirectional, the motion vector is detected with a lower precision than the predetermined precision, using the encoding target image and the reference image; the encoding target image is encoded by performing a motion compensation operation using the motion vector; and the encoded encoding target image and the motion vector are transmitted.

### Effects of the Invention

According to the first aspect of the present technique, when a motion compensation operation with fractional precision is performed upon inter prediction, an image encoded so as to improve encoding efficiency can be decoded.

According to the second aspect of the present technique, when a motion compensation operation with fractional precision is performed upon inter prediction, encoding efficiency can be improved.

### BRIEF DESCRIPTION OF DRAWINGS

FIG. 1 is a block diagram showing an example structure of an embodiment of an encoding device to which the present technique is applied.

FIG. 2 is a block diagram showing an example structure of a motion prediction unit shown in FIG. 1.

FIG. 3 is a first flowchart for explaining an encoding operation by the encoding device shown in FIG. 1.

FIG. 4 is a second flowchart for explaining an encoding operation by the encoding device shown in FIG. 1.

FIG. 5 is a first flowchart for explaining an L0 motion prediction operation.

FIG. 6 is a second flowchart for explaining a bidirectional motion prediction operation.

FIG. 7 is a block diagram showing an example structure of a decoding device to which the present technique is applied.

FIG. 8 is a flowchart for explaining a decoding operation by the decoding device shown in FIG. 7.

FIG. 9 is a block diagram showing an example structure of an embodiment of a computer.

FIG. 10 is a block diagram showing a typical example structure of a television receiver.

FIG. 11 is a block diagram showing a typical example structure of a portable telephone device.

FIG. 12 is a block diagram showing a typical example structure of a hard disk recorder.

FIG. 13 is a block diagram showing a typical example structure of a camera.

### MODES FOR CARRYING OUT THE INVENTION

### Embodiment

### Example Structure of an Embodiment of an Encoding Device

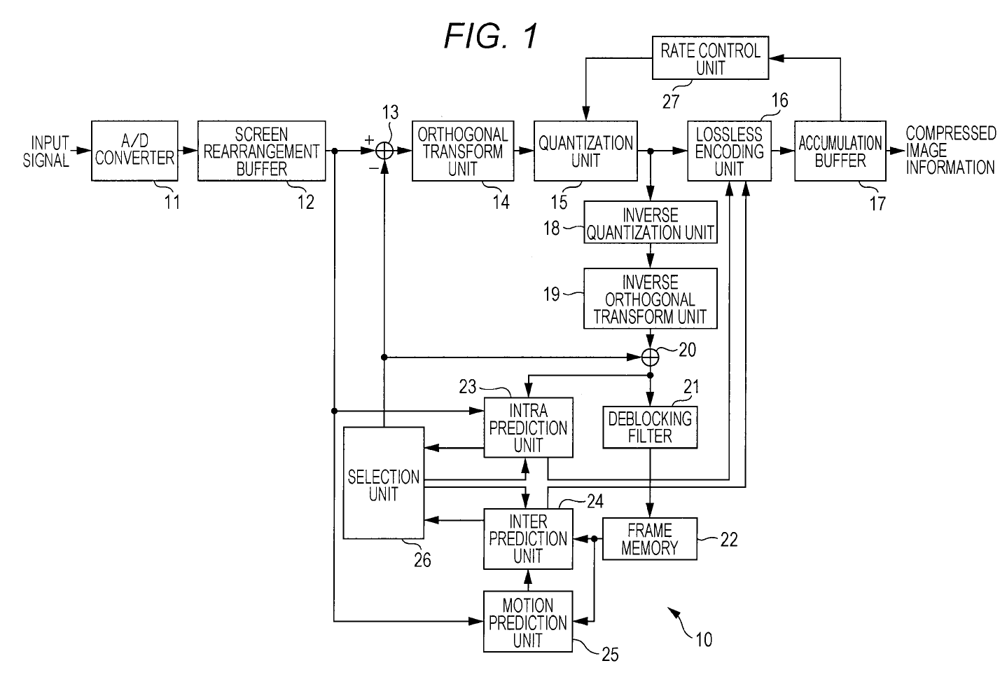

FIG. 1 is a block diagram showing an example structure of an embodiment of an encoding device to which the present technique is applied.

The encoding device 10 shown in FIG. 1 includes an A/D converter 11, a screen rearrangement buffer 12, an arithmetic operation unit 13, an orthogonal transform unit 14, a quantization unit 15, a lossless encoding unit 16, an accumulation buffer 17, an inverse quantization unit 18, an inverse orthogonal transform unit 19, an addition unit 20, a deblocking filter 21, a frame memory 22, an intra prediction unit 23, an inter prediction unit 24, a motion prediction unit 25, a selection unit 26, and a rate control unit 27. The encoding device 10 shown in FIG. 1 performs compression encoding on an input image.

Specifically, the A/D converter 11 of the encoding device 10 performs an A/D conversion on a frame-based image input as an input signal, and outputs and stores the image into the screen rearrangement buffer 12. The screen rearrangement buffer 12 rearranges the frames of the image stored in displaying order, so that the frames of the image are arranged in encoding order in accordance with the GOP (Group of Pictures) structure. The screen rearrangement buffer 12 then sequentially divides the rearranged image slice by slice, LCU by LCU (Largest Coding Unit), and CU by CU (Coding Unit), and outputs the resultant image to the arithmetic operation unit 13, the intra prediction unit 23, and the motion prediction unit 25.

The arithmetic operation unit 13 functions as an encoding unit, and performs encoding by calculating a difference between a predicted image supplied from the selection unit 26 and the encoding target image output from the screen rearrangement buffer 12. Specifically, the arithmetic operation unit 13 subtracts a predicted image supplied from the selection unit 26 from an encoding target image output from the screen rearrangement buffer 12. The arithmetic operation unit 13 outputs the image obtained as a result of the subtraction, as residual error information to the orthogonal trans form unit 14. When any predicted image is not supplied from the selection unit 26, the arithmetic operation unit 13 outputs an image read from the screen rearrangement buffer 12 as the residual error information to the orthogonal transform unit 14.

The orthogonal transform unit 14 performs an orthogonal transform, such as a discrete cosine transform or a Karhunen-Loeve transform, on the residual error information supplied from the arithmetic operation unit 13, and supplies the resultant coefficients to the quantization unit 15.

The quantization unit 15 quantizes the coefficients supplied from the orthogonal transform unit 14. The quantized coefficients are input to the lossless encoding unit 16.

The lossless encoding unit 16 obtains information indicating an optimum intra prediction mode (hereinafter referred to as intra prediction mode information) from the intra prediction unit 23, and obtains information indicating an optimum inter prediction mode (hereinafter referred to as inter prediction mode information), a difference vector (mvd) which is a difference between a motion vector of a prediction block and a predicted vector, and the like, from the inter prediction unit 24.

The lossless encoding unit 16 performs lossless encoding, such as variable-length encoding (CAVLC (Context-Adaptive Variable Length Coding), for example) or arithmetic encoding (CABAC (Context-Adaptive Binary Arithmetic Coding), for example), on the quantized coefficients supplied from the quantization unit 15, and turns the resultant information into a compressed image.

When a difference vector is obtained, the lossless encoding unit 16 also binarizes the absolute value of the difference vector using an exponential-Golomb code. The exponential-Golomb code consists of a prefix with consecutive 0s, the number of which corresponds to the number of bits of the suffix which is a data portion; 1 serving as a separator; and a sequence of 0s or 1s serving as the suffix. Therefore, the larger the number of bits of the absolute value of the difference vector, i.e., the higher the resolution of the absolute value of the difference vector, the larger the exponential-Golomb code amount. The lossless encoding unit 16 generates the binarized absolute value of the difference vector and the sign of the difference vector, as difference vector information.

The lossless encoding unit 16 also performs lossless encoding on the intra prediction mode information or the inter prediction mode information, the difference vector information, and the like, and sets the resultant information as header information to be added to the compressed image. The lossless encoding unit 16 supplies and stores the compressed image to which the header information obtained as a result of the lossless encoding is added, as compressed image information into the accumulation buffer 17.

The accumulation buffer 17 temporarily stores the compressed image information supplied from the lossless encoding unit 16. The accumulation buffer 17 also functions as a transmission unit, and transmits the information to a recording device, a transmission path, or the like (not shown) in a later stage, for example.

The quantized coefficients that are output from the quantization unit 15 are also input to the inverse quantization unit 18, and after inversely quantized, are supplied to the inverse orthogonal transform unit 19.

The inverse orthogonal transform unit 19 performs an inverse orthogonal transform such as an inverse discrete cosine transform or an inverse Karhunen-Loeve transform on the coefficients supplied from the inverse quantization unit 18, and supplies the resultant residual error information to the addition unit 20.

The addition unit 20 adds the residual error information supplied from the inverse orthogonal transform unit 19 and serving as a decoding target image to the predicted image supplied from the selection unit 26, to obtain a locally decoded image. If there are no predicted images supplied from the selection unit 26, the addition unit 20 sets the residual error information supplied from the inverse orthogonal transform unit 19 as a locally decoded image. The addition unit 20 supplies the locally decoded image to the deblocking filter 21, and supplies the locally decoded image as a reference image to the intra prediction unit 23.

The deblocking filter 21 performs filtering on the locally decoded image supplied from the addition unit 20, to remove block distortions. The deblocking filter 21 supplies and stores the resultant image into the frame memory 22. The image stored in the frame memory 22 is then output as a reference image to the inter prediction unit 24 and the motion prediction unit 25.

Based on the image read from the screen rearrangement buffer 12 and the reference image supplied from the addition unit 20, the intra prediction unit 23 performs intra predictions in all candidate intra prediction modes, and generates predicted images.

At this point, the intra prediction unit 23 calculates cost function values (details will be described later) for all of the candidate intra prediction modes. The intra prediction unit 23 then determines the intra prediction mode with the smallest cost function value to be an optimum intra prediction mode. The intra prediction unit 23 supplies the predicted image generated in the optimum intra prediction mode and the corresponding cost function value to the selection unit 26. When notified of selection of the predicted image generated in the optimum intra prediction mode by the selection unit 26, the intra prediction unit 23 supplies the intra prediction mode information to the lossless encoding unit 16.

It should be noted that a cost function value is also called a RD (Rate Distortion) cost, and is calculated by the technique of High Complexity mode or Low Complexity mode, as specified in the JM (Joint Model), which is the reference software in H.264/AVC, for example.

Specifically, where the High Complexity mode is used as a method of calculating cost function values, operations ending with the lossless encoding are provisionally carried out on all candidate prediction modes, and a cost function value expressed by the following equation (1) is calculated for each of the prediction modes.

Cost(Mode)=D+λ·R (1)

D represents the difference (distortion) between the original image and the decoded image, R represents the bit generation rate including the orthogonal transform coefficient, and λ represents the Lagrange multiplier given as the function of a quantization parameter QP.

Where the Low Complexity mode is used as the method of calculating cost function values, on the other hand, decoded images are generated, and header bits such as information indicating a prediction mode are calculated in all the candidate prediction modes. A cost function value expressed by the following equation (2) is then calculated for each of the prediction modes.

Cost(Mode)=D+QPtoQuant(QP)·Header_Bit (2)

D represents the difference (distortion) between the original image and the decoded image, Header_Bit represents the header bit corresponding to the prediction mode, and QPtoQuant is the function given as the function of the quantization parameter QP.

In the Low Complexity mode, decoded images are simply generated in all the prediction modes, and there is no need to perform lossless encoding. Accordingly, the amount of calculation is small. It should be noted that the High Complexity mode is used as the method of calculating cost function values herein.

Based on inter prediction mode information and a motion vector supplied from the motion prediction unit 25, the inter prediction unit 24 reads the reference image from the frame memory 22. Based on the motion vector and the reference image read from the frame memory 22, the inter prediction unit 24 performs an inter prediction operation. Specifically, the inter prediction unit 24 performs interpolations on the reference image based on the motion vector, to perform a motion compensation operation with fractional precision. The inter prediction unit 24 supplies the resultant predicted image and a cost function value supplied from the motion prediction unit 25, to the selection unit 26.

Note that the inter prediction mode refers to information indicating the size of a prediction block, a prediction direction, a reference index, and an encoding mode. The prediction direction includes a forward prediction (L0 prediction) that uses a reference image earlier in display time than an image to be subjected to an inter prediction; a backward prediction (L1 prediction) that uses a reference image later in display time than the image to be subjected to the inter prediction; and a bidirectional prediction (Bi-prediction) that uses the reference images earlier and later in display time than the image to be subjected to the inter prediction.

A reference index is a number for identifying a reference image, and an image that is located closer to an image to be subjected to an inter prediction has a smaller reference index number, for example. The encoding mode includes a skip mode where the difference vector and the residual error information are set to 0 so as not to transmit difference vector information and the residual error information; a merge mode where only the difference vector is set to 0 so as to transmit the residual error information, but not to transmit difference vector information; a normal mode where neither of the difference vector and the residual error information is set to 0 so as to transmit difference vector information and the residual error information; and the like.

When notified of selection of the predicted image generated in the optimum inter prediction mode by the selection unit 26, the inter prediction unit 24 also determines a difference vector from the motion vector and the predicted vector. As the predicted vector (pmv), among the motion vectors of prediction blocks spatially close to the current prediction block and of neighboring prediction blocks temporally close to the current prediction block, a motion vector whose difference from the motion vector of the current prediction block is smallest is used. The inter prediction unit 24 outputs the determined difference vector, the inter prediction mode information, pmv selection information indicating the motion vector selected as the predicted vector, detected-precision information, and the like, to the lossless encoding unit 16. Note that the detected-precision information is information indicating that the precision of the motion vector for when the prediction direction is bidirectional is lower than the precision of the motion vector for when the prediction direction is the L0 prediction or the L1 prediction.

Based on the image supplied from the screen rearrangement buffer 12 and the reference image supplied from the frame memory 22, the motion prediction unit 25 detects motion vectors in all of the candidate inter prediction modes, with fractional precisions according to the prediction directions of the inter prediction modes.

The motion prediction unit 25 also calculates cost function values for all of the candidate inter prediction modes, and determines the inter prediction mode with the smallest cost function value to be an optimum inter prediction mode. The motion prediction unit 25 then supplies the inter prediction mode information, the corresponding motion vector, and the corresponding cost function value to the inter prediction unit 24.

Based on the cost function values supplied from the intra prediction unit 23 and the inter prediction unit 24, the selection unit 26 determines the optimum intra prediction mode or the optimum inter prediction mode to be an optimum prediction mode. The selection unit 26 then supplies the predicted image in the optimum prediction mode to the arithmetic operation unit 13 and the addition unit 20. The selection unit 26 also notifies the intra prediction unit 23 or the inter prediction unit 24 of the selection of the predicted image in the optimum prediction mode.

Based on the compressed image information stored in the accumulation buffer 17, the rate control unit 27 controls the quantization operation rate of the quantization unit 15 so as not to cause an overflow or underflow.

[Example Structure of the Motion Prediction Unit]

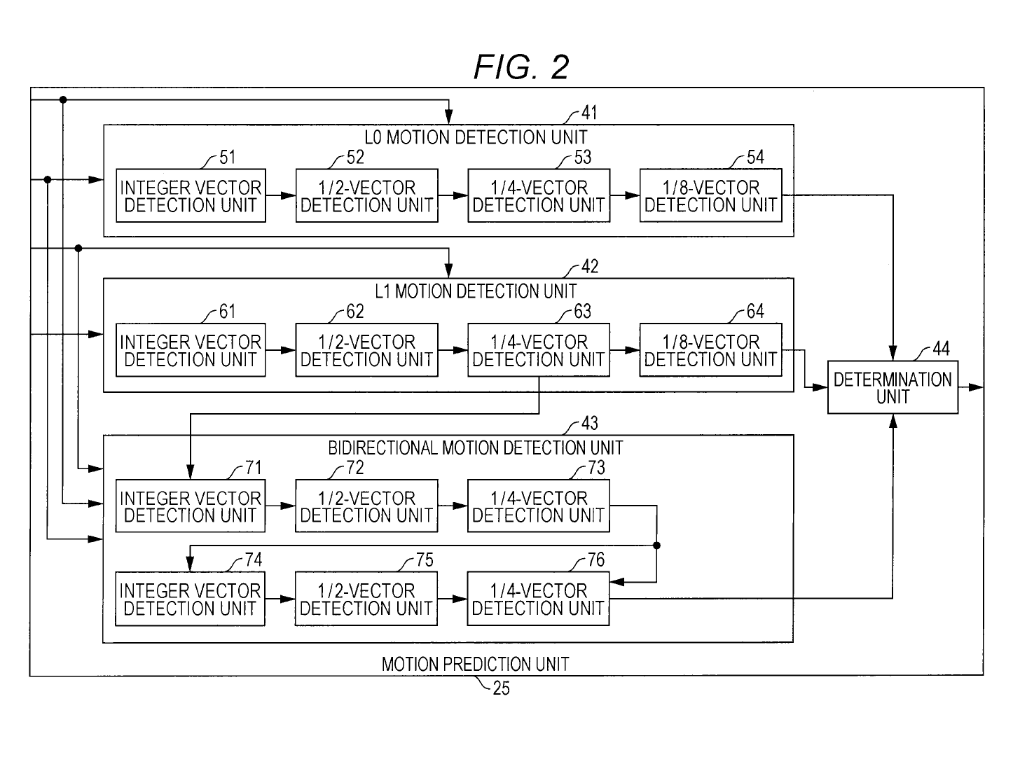

FIG. 2 is a block diagram showing an example structure of the motion prediction unit 25 shown in FIG. 1.

In FIG. 2, the motion prediction unit 25 includes an L0 motion detection unit 41, an L1 motion detection unit 42, a bidirectional motion detection unit 43, and a determination unit 44.

The L0 motion detection unit 41 functions as high-precision motion detection unit, and includes an integer vector detection unit 51, a ½-vector detection unit 52, a ¼-vector detection unit 53, and a ⅛-vector detection unit 54. The L0 motion detection unit 41 detects, with ⅛-pixel precision, a motion vector for each inter prediction mode indicating the L0 prediction as the prediction direction.

Specifically, an encoding target image supplied from the screen rearrangement buffer 12 and an image earlier in display time than the encoding target image which is read from the frame memory 22 and serves as a reference image are supplied to the L0 motion detection unit 41, for each inter prediction mode indicating the L0 prediction as the prediction direction.

Using the encoding target image and the reference image, the integer vector detection unit 51 detects a motion vector with integer pixel precision, for each inter prediction mode indicating the L0 prediction as the prediction direction. Specifically, the integer vector detection unit 51 detects a block of the reference image whose difference from a prediction block of the encoding target image is smallest. The integer vector detection unit 51 then detects a motion vector indicating the position of the detected block of the reference image with respect to the position of the prediction block, as the motion vector of the reference image with integer pixel precision for the prediction block. The integer vector detection unit 51 supplies the detected motion vector with integer pixel precision to the ½-vector detection unit 52.

Based on the motion vector with integer pixel precision supplied from the integer vector detection unit 51, the ½-vector detection unit 52 performs interpolations on the reference image. By this, the ½-vector detection unit 52 generates a reference block of 3×3 pixels with the position corresponding to the motion vector being at the center thereof and with intervals in the horizontal and vertical directions being in a ½ pixel position.

As with the integer vector detection unit 51, using the generated reference block and the encoding target image, the ½-vector detection unit 52 then detects a motion vector with ½-pixel precision, for each inter prediction mode indicating the L0 prediction as the prediction direction. The ½-vector detection unit 52 supplies the detected motion vector with ½-pixel precision to the ¼-vector detection unit 53.

Based on the motion vector with ½-pixel precision supplied from the ½-vector detection unit 52, the ¼-vector detection unit 53 performs interpolations on the reference image. By this, the ¼-vector detection unit 53 generates a reference block of 3×3 pixels with the position corresponding to the motion vector being at the center thereof and with intervals in the horizontal and vertical directions being in a ¼ pixel position.

As with the integer vector detection unit 51, using the generated reference block and the encoding target image, the ¼-vector detection unit 53 then detects a motion vector with ¼-pixel precision, for each inter prediction mode indicating the L0 prediction as the prediction direction. The ¼-vector detection unit 53 supplies the detected motion vector with ¼-pixel precision to the ⅛-vector detection unit 54.

Based on the motion vector with ¼-pixel precision supplied from the ¼-vector detection unit 53, the ⅛-vector detection unit 54 performs interpolations on the reference image. By this, the ⅛-vector detection unit 54 generates a reference block of 3×3 pixels with the position corresponding to the motion vector being at the center thereof and with intervals in the horizontal and vertical directions being in a ⅛ pixel position.

As with the integer vector detection unit 51, using the generated reference block and the encoding target image, the ⅛-vector detection unit 54 then detects a motion vector with ⅛-pixel precision, for each inter prediction mode indicating the L0 prediction as the prediction direction.

Using the detected motion vector with ⅛-pixel precision for each inter prediction mode indicating the L0 prediction as the prediction direction, and the like, the ⅛-vector detection unit 54 also calculates a cost function value for the inter prediction mode. The ⅛-vector detection unit 54 then determines the inter prediction mode with the smallest cost function value to be an optimum inter prediction mode indicating the L0 prediction as the prediction direction (hereinafter referred to as optimum L0 inter prediction mode). The ⅛-vector detection unit 54 supplies the optimum L0 inter prediction mode, the corresponding cost function value, and the corresponding motion vector to the determination unit 44.

The L1 motion detection unit 42 functions as high-precision motion detection unit, and includes an integer vector detection unit 61, a ½-vector detection unit 62, a ¼-vector detection unit 63, and a ⅛-vector detection unit 64. The L1 motion detection unit 42 detects, with ⅛-pixel precision, a motion vector for each inter prediction mode indicating the L1 prediction as the prediction direction.

Note that the operations of the respective components of the L1 motion detection unit 42 are the same as the operations of the respective components of the L0 motion detection unit 41, except that the operations are performed for each inter prediction mode indicating the L1 prediction as the prediction direction, and an image later in display time than an encoding target image is read as a reference image from the frame memory 22, and thus, description of the operations is omitted.

The bidirectional motion detection unit 43 functions as low-precision motion detection unit, and includes an integer vector detection unit 71, a ½-vector detection unit 72, a ¼-vector detection unit 73, an integer vector detection unit 74, a ½-vector detection unit 75, and a ¼-vector detection unit 76. The bidirectional motion detection unit 43 detects, with ¼-pixel precision, a motion vector for each inter prediction mode indicating the Bi-prediction as the prediction direction.

Specifically, an encoding target image supplied from the screen rearrangement buffer 12 and images earlier and later in display time than the encoding target image which are read from the frame memory 22 and serve as reference images are supplied to the bidirectional motion detection unit 43, for each inter prediction mode indicating the Bi-prediction as the prediction direction.

Based on the backward motion vector with ¼-pixel precision detected by the ¼-vector detection unit 63, the integer vector detection unit 71 performs interpolations on the reference image later in display time than the encoding target image (hereinafter referred to as backward reference image). By this, the integer vector detection unit 71 generates a backward reference block of 3×3 pixels with the position corresponding to the motion vector being at the center thereof and with intervals in the horizontal and vertical directions being in a ¼ pixel position.

Using the backward reference block, the reference image earlier in display time than the encoding target image (hereinafter referred to as forward reference image), and the encoding target image, the integer vector detection unit 71 detects a forward motion vector with integer pixel precision, for each inter prediction mode indicating the Bi-prediction as the prediction direction. Specifically, the integer vector detection unit 71 combines the backward reference block with the forward reference image for each inter prediction mode indicating the Bi-prediction as the prediction direction, and detects a block of the forward reference image with the smallest difference between the resultant image and a prediction block of the encoding target image. The integer vector detection unit 71 then detects a motion vector indicating the position of the detected block of the forward reference image with respect to the position of the prediction block, as the forward motion vector with integer pixel precision. The integer vector detection unit 71 supplies the detected forward motion vector with integer pixel precision to the ½-vector detection unit 72.

Based on the forward motion vector with integer pixel precision supplied from the integer vector detection unit 71, the ½-vector detection unit 72 performs interpolations on the forward reference image. By this, the ½-vector detection unit 72 generates a forward reference block of 3×3 pixels with the position corresponding to the motion vector being at the center thereof and with intervals in the horizontal and vertical directions being in a ½ pixel position.

As with the integer vector detection unit 71, using the generated forward reference block, the backward reference block, and the encoding target image, the ½-vector detection unit 72 then detects a forward motion vector with ½-pixel precision, for each inter prediction mode indicating the Bi-prediction as the prediction direction. The ½-vector detection unit 72 supplies the detected forward motion vector with ½-pixel precision to the ¼-vector detection unit 73.

Based on the forward motion vector with ½-pixel precision supplied from the ½-vector detection unit 72, the ¼-vector detection unit 73 performs interpolations on the forward reference image. By this, the ¼-vector detection unit 73 generates a forward reference block of 3×3 pixels with the position corresponding to the motion vector being at the center thereof and with intervals in the horizontal and vertical directions being in a ¼ pixel position.

As with the integer vector detection unit 71, using the generated forward reference block, the backward reference block, and the encoding target image, the ¼-vector detection unit 73 then detects a forward motion vector with ¼-pixel precision, for each inter prediction mode indicating the Bi-prediction as the prediction direction. The ¼-vector detection unit 73 supplies the detected forward motion vector with ¼-pixel precision to the integer vector detection unit 74 and the ¼-vector detection unit 76.

Based on the forward motion vector with ¼-pixel precision supplied from the ¼-vector detection unit 73, the integer vector detection unit 74 performs interpolations on the forward reference image. By this, the integer vector detection unit 74 generates a forward reference block of 3×3 pixels with the position corresponding to the motion vector being at the center thereof and with intervals in the horizontal and vertical directions being in a ¼ pixel position.

As with the integer vector detection unit 71, using the forward reference block, the backward reference image, and the encoding target image, the integer vector detection unit 74 detects a backward motion vector with integer pixel precision, for each inter prediction mode indicating the Bi-prediction as the prediction direction. The integer vector detection unit 74 supplies the detected backward motion vector with integer pixel precision to the ½-vector detection unit 75.

The operations of the ½-vector detection unit 75 and the ¼-vector detection unit 76 are the same as the operations of the ½-vector detection unit 72 and the ¼-vector detection unit 73, except that interpolations are performed on the backward reference image instead of the forward reference image, and a backward motion vector is detected instead of a forward motion vector.

Note, however, that the ¼-vector detection unit 76 calculates, using the forward motion vector with ¼-pixel precision supplied from the ¼-vector detection unit 73, the backward motion vector with ¼-pixel precision, and the like, which are obtained for each inter prediction mode indicating the Bi-prediction as the prediction direction, a cost function value for the inter prediction mode. The ¼-vector detection unit 76 then determines the inter prediction mode with the smallest cost function value to be an optimum inter prediction mode indicating the Bi-prediction as the prediction direction (hereinafter referred to as optimum bidirectional inter prediction mode). The ¼-vector detection unit 76 supplies the optimum bidirectional inter prediction mode, the corresponding cost function value, and the corresponding motion vector to the determination unit 44.

The determination unit 44 detects the smallest value from among the cost function values supplied from the ⅛-vector detection unit 54, the ⅛-vector detection unit 64, and the ¼-vector detection unit 76. The determination unit 44 determines one of the optimum L0 inter prediction mode, an optimum inter prediction mode indicating the L1 prediction as the prediction direction (hereinafter referred to as optimum L1 inter prediction mode), and the optimum bidirectional inter prediction mode that is supplied in association with the smallest value, to be an optimum inter prediction mode. The determination unit 44 supplies inter prediction mode information, the corresponding motion vector, and the corresponding cost function value to the inter prediction unit 24 (FIG. 1).

[Description of an Operation of the Encoding Device]

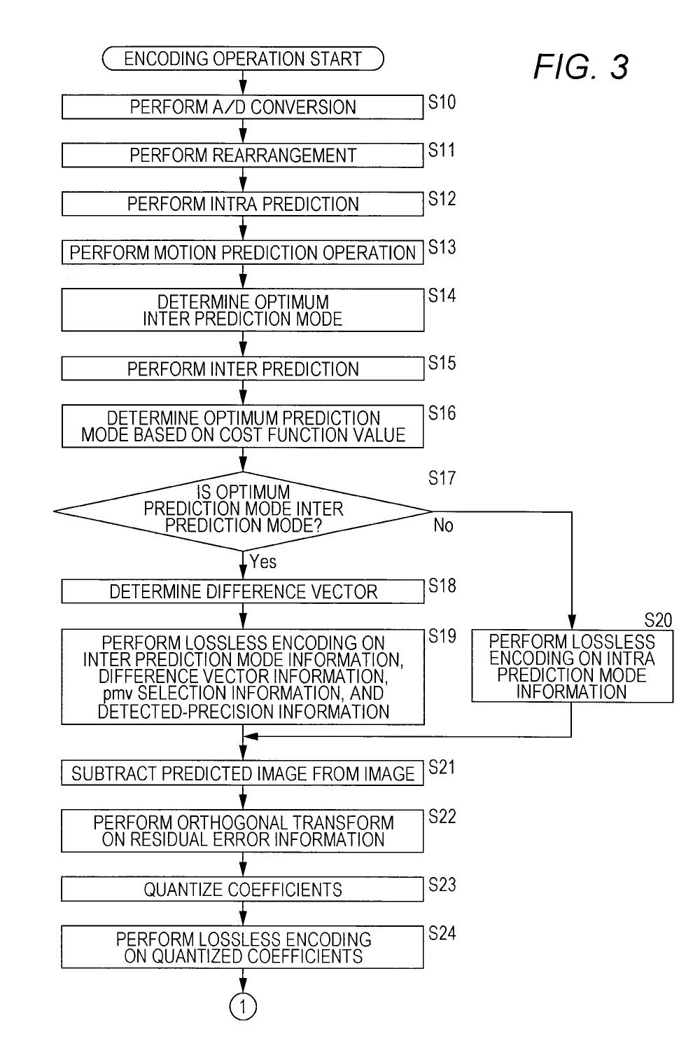

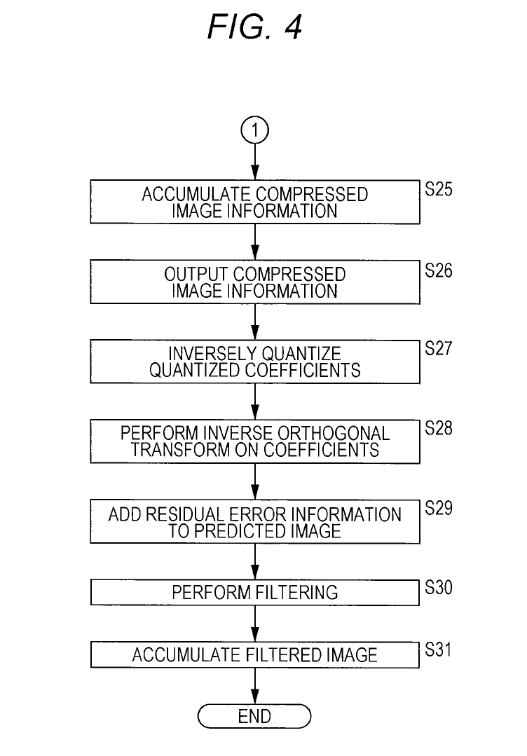

FIGS. 3 and 4 are flowcharts for explaining an encoding operation by the encoding device 10 shown in FIG. 1. This encoding operation is performed every time a frame-based image is input as an input signal to the encoding device 10, for example.

In step S10 of FIG. 3, the A/D converter 11 of the encoding device 10 performs an A/D conversion on a frame-based image input as an input signal, and outputs and stores the image into the screen rearrangement buffer 12.

In step S11, the screen rearrangement buffer 12 rearranges the frames of the image stored in displaying order, so that the frames of the image are arranged in encoding order in accordance with the GOP structure. The screen rearrangement buffer 12 sequentially divides the rearranged frame-based image slice by slice, LCU, and CU by CU, and supplies the resultant image to the arithmetic operation unit 13, the intra prediction unit 23, and the motion prediction unit 25. The procedures of subsequent steps S12 to S31 are performed on a CU-by-CU basis, for example.

In step S12, based on the image supplied from the screen rearrangement buffer 12 and a reference image supplied from the addition unit 20, the intra prediction unit 23 performs intra predictions in all candidate intra prediction modes, and generates predicted images. The intra prediction unit 23 also calculates cost function values for all the candidate intra prediction modes. The intra prediction unit 23 then determines the intra prediction mode with the smallest cost function value to be an optimum intra prediction mode. The intra prediction unit 23 supplies the predicted image generated in the optimum intra prediction mode and the corresponding cost function value to the selection unit 26.

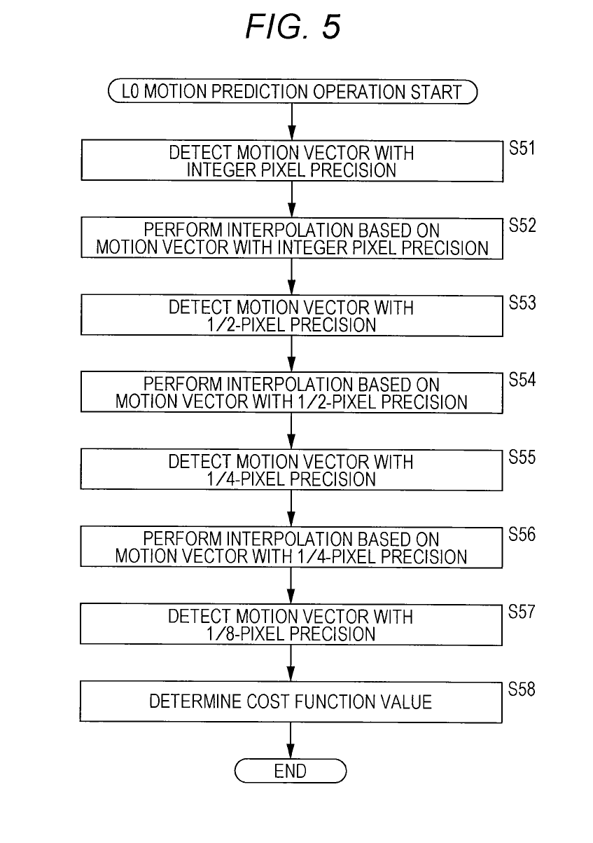

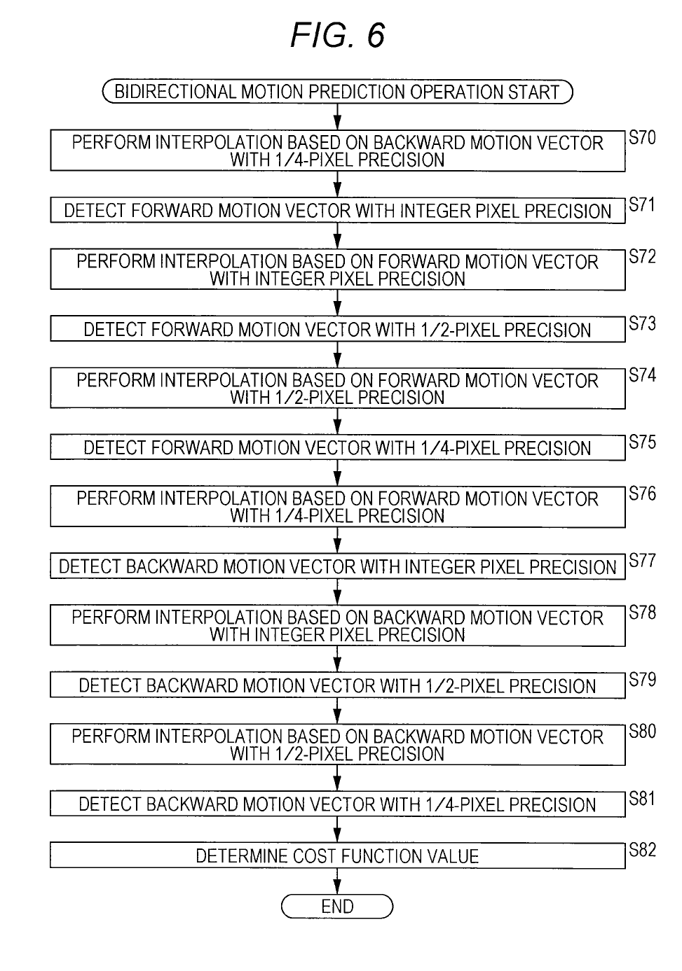

In step S13, the motion prediction unit 25 performs a motion prediction operation in all of the candidate inter prediction modes on the image supplied from the screen rearrangement buffer 12, using a reference image supplied from the frame memory 22. Details of the motion prediction operation will be described with reference to FIGS. 5 and 6 which will be described later.

In step S14, the determination unit 44 of the motion prediction unit 25 (FIG. 2) determines the inter prediction mode with the smallest cost function value which is obtained in the motion prediction operation in step S13, to be an optimum inter prediction mode. The determination unit 44 then supplies inter prediction mode information, the corresponding motion vector, and the corresponding cost function value to the inter prediction unit 24.

In step S15, based on the motion vector and the inter prediction mode information which are supplied from the motion prediction unit 25, the inter prediction unit 24 performs an inter prediction in the optimum inter prediction mode, and generates a predicted image. The inter prediction unit 24 supplies the generated predicted image and the cost function value supplied from the motion prediction unit 25, to the selection unit 26.

In step S16, based on the cost function values supplied from the intra prediction unit 23 and the inter prediction unit 24, the selection unit 26 determines an optimum prediction mode that is the optimum intra prediction mode or the optimum inter prediction mode, whichever has the smallest cost function value. The selection unit 26 then supplies the predicted image in the optimum prediction mode to the arithmetic operation unit 13 and the addition unit 20.

In step S17, the selection unit 26 determines whether the optimum prediction mode is the optimum inter prediction mode. If the optimum prediction mode is determined to be the optimum inter prediction mode in step S17, the selection unit 26 notifies the inter prediction unit 24 of selection of the predicted image generated in the optimum inter prediction mode.

Then, in step S18, the inter prediction unit 24 determines a difference vector from the motion vector and the predicted vector. At this point, when the precision of the motion vector is ¼-pixel precision and the precision of the predicted vector is ⅛-pixel precision, the inter prediction unit 24 functions as a predicted-vector transform unit, and performs a rounding operation on the predicted vector to generate a predicted vector with ¼-pixel precision. The inter prediction unit 24 then determines a difference vector using the predicted vector with ¼-pixel precision. The inter prediction unit 24 outputs the determined difference vector, the inter prediction mode information, pmv selection information, and detected-precision information to the lossless encoding unit 16.

In step S19, the lossless encoding unit 16 generates difference vector information from the difference vector supplied from the inter prediction unit 24, and performs lossless encoding on the inter prediction mode information, the difference vector information, the pmv selection information, and the detected-precision information. The lossless encoding unit 16 sets the resultant information as header information to be added to the compressed image, and the operation moves on to step S21.

If the optimum prediction mode is determined not to be the optimum inter prediction mode in step S17, or if the optimum prediction mode is determined to be the optimum intra prediction mode, on the other hand, the selection unit 26 notifies the intra prediction unit 23 of selection of the predicted image generated in the optimum intra prediction mode. Accordingly, the intra prediction unit 23 supplies the intra prediction mode information to the lossless encoding unit 16.

In step S20, the lossless encoding unit 16 performs lossless encoding on the intra prediction mode information and the like supplied from the intra prediction unit 23, and sets the resultant information as the header information to be added to the compressed image. The operation then moves on to step S21.

In step S21, the arithmetic operation unit 13 subtracts the predicted image supplied from the selection unit 26 from the image supplied from the screen rearrangement buffer 12. The arithmetic operation unit 13 outputs the image obtained as a result of the subtraction, as residual error information to the orthogonal transform unit 14.

In step S22, the orthogonal transform unit 14 performs an orthogonal transform on the residual error information supplied from the arithmetic operation unit 13, and supplies the resultant coefficients to the quantization unit 15.

In step S23, the quantization unit 15 quantizes the coefficients supplied from the orthogonal transform unit 14. The quantized coefficients are input to the lossless encoding unit 16 and the inverse quantization unit 18.

In step S24, the lossless encoding unit 16 performs lossless encoding on the quantized coefficients supplied from the quantization unit 15, and sets the resultant information as the compressed image. The lossless encoding unit 16 then adds the header information generated through the procedure of step S19 or S20 to the compressed image, to generate compressed image information.

In step S25 of FIG. 4, the lossless encoding unit 16 supplies and stores the compressed image information into the accumulation buffer 17.

In step S26, the accumulation buffer 17 outputs the stored compressed image information to a recording device, a transmission path, or the like (not shown) in a later stage, for example.

In step S27, the inverse quantization unit 18 inversely quantizes the quantized coefficients supplied from the quantization unit 15.

In step S28, the inverse orthogonal transform unit 19 performs an inverse orthogonal transform on the coefficients supplied from the inverse quantization unit 18, and supplies the resultant residual error information to the addition unit 20.

In step S29, the addition unit 20 adds the residual error information supplied from the inverse orthogonal transform unit 19 to the predicted image supplied from the selection unit 26, and obtains a locally decoded image. The addition unit 20 supplies the obtained image to the deblocking filter 21, and also supplies the obtained image as a reference image to the intra prediction unit 23.

In step S30, the deblocking filter 21 performs filtering on the locally decoded image supplied from the addition unit 20, to remove block distortions.

In step S31, the deblocking filter 21 supplies and stores the filtered image into the frame memory 22. The image stored in the frame memory 22 is then output as a reference image to the inter prediction unit 24 and the motion prediction unit 25. The operation then comes to an end.

Note that although in the encoding operation shown in FIGS. 3 and 4, for simplification of description, an intra prediction operation and a motion compensation operation are always performed, in practice only one of the operations may be performed depending on the picture type or the like. Note also that although difference vector information and quantized coefficients are always subjected to lossless encoding at the lossless encoding unit 16, in practice lossless encoding may not be performed depending on the encoding mode. Specifically, in the case of the skip mode, difference vector information and quantized coefficients are not subjected to lossless encoding, and in the case of the merge mode, difference vector information is not subjected to lossless encoding.

FIG. 5 is a flowchart for explaining an L0 motion prediction operation performed during the motion prediction operation in step S13 of FIG. 3. In the L0 motion prediction operation, motion vectors in inter prediction modes indicating the L0 prediction as the prediction direction are detected.

In step S51, using an encoding target image supplied from the screen rearrangement buffer 12 and a forward reference image read from the frame memory 22, the integer vector detection unit 51 detects a motion vector with integer pixel precision for each inter prediction mode indicating the L0 prediction as the prediction direction. The integer vector detection unit 51 supplies the detected motion vector with integer pixel precision to the ½-vector detection unit 52.

In step S52, based on the motion vector with integer pixel precision supplied from the integer vector detection unit 51, the ½-vector detection unit 52 performs interpolations on the forward reference image. By this, the ½-vector detection unit 52 generates a reference block of 3×3 pixels with the position corresponding to the motion vector being at the center thereof and with intervals in the horizontal and vertical directions being in a ½ pixel position.

In step S53, as with the integer vector detection unit 51, using the generated reference block and the encoding target image, the ½-vector detection unit 52 detects a motion vector with ½-pixel precision, for each inter prediction mode indicating the L0 prediction as the prediction direction. The ½-vector detection unit 52 supplies the detected motion vector with ½-pixel precision to the ¼-vector detection unit 53.

In step S54, based on the motion vector with ½-pixel precision supplied from the ½-vector detection unit 52, the ¼-vector detection unit 53 performs interpolations on the forward reference image. By this, the ¼-vector detection unit 53 generates a reference block of 3×3 pixels with the position corresponding to the motion vector being at the center thereof and with intervals in the horizontal and vertical directions being in a ¼ pixel position.

In step S55, as with the integer vector detection unit 51, using the generated reference block and the encoding target image, the ¼-vector detection unit 53 detects a motion vector with ¼-pixel precision, for each inter prediction mode indicating the L0 prediction as the prediction direction. The ¼-vector detection unit 53 supplies the detected motion vector with ¼-pixel precision to the ⅛-vector detection unit 54.

In step S56, based on the motion vector with ¼-pixel precision supplied from the ¼-vector detection unit 53, the ⅛-vector detection unit 54 performs interpolations on the reference image. By this, the ⅛-vector detection unit 54 generates a reference block of 3×3 pixels with the position corresponding to the motion vector being at the center thereof and with intervals in the horizontal and vertical directions being in a ⅛ pixel position.

In step S57, as with the integer vector detection unit 51, using the generated reference block and the encoding target image, the ⅛-vector detection unit 54 detects a motion vector with ⅛-pixel precision, for each inter prediction mode indicating the L0 prediction as the prediction direction.

In step S58, using the detected motion vector with ⅛-pixel precision for each inter prediction mode indicating the L0 prediction as the prediction direction, and the like, the ⅛-vector detection unit 54 determines a cost function value for the inter prediction mode. The ⅛-vector detection unit 54 then determines the inter prediction mode with the smallest cost function value to be an optimum L0 inter prediction mode, and supplies the optimum L0 inter prediction mode, the corresponding cost function value, and the corresponding motion vector to the determination unit 44.

Note that an L1 motion prediction operation in which motion vectors in inter prediction modes indicating the L1 prediction as the prediction direction are detected is the same as the L0 motion prediction operation shown in FIG. 5, and thus, description thereof is omitted.

FIG. 6 is a flowchart for explaining a bidirectional motion prediction operation performed during the motion prediction operation in step S13 of FIG. 3. In the bidirectional motion prediction operation, motion vectors in inter prediction modes indicating the Bi-prediction as the prediction direction are detected.

In step S70, based on a backward motion vector with ¼-pixel precision detected by the ¼-vector detection unit 63, the integer vector detection unit 71 performs interpolations on a backward reference image read from the frame memory 22. By this, the integer vector detection unit 71 generates a backward reference block of 3×3 pixels with the position corresponding to the motion vector being at the center thereof and with intervals in the horizontal and vertical directions being in a ½ pixel position.

In step S71, using the backward reference block, the forward reference image, and the encoding target image, the integer vector detection unit 71 detects a forward motion vector with integer pixel precision, for each inter prediction mode indicating the Bi-prediction as the prediction direction. The integer vector detection unit 71 supplies the detected forward motion vector with integer pixel precision to the ½-vector detection unit 72.

In step S72, based on the forward motion vector with integer pixel precision supplied from the integer vector detection unit 71, the ½-vector detection unit 72 performs interpolations on the forward reference image. By this, the ½-vector detection unit 72 generates a forward reference block of 3×3 pixels with the position corresponding to the motion vector being at the center thereof and with intervals in the horizontal and vertical directions being in a ½ pixel position.

In step S73, as with the integer vector detection unit 71, using the generated forward reference block, the backward reference block, and the encoding target image, the ½-vector detection unit 72 detects a forward motion vector with ½-pixel precision, for each inter prediction mode indicating the Bi-prediction as the prediction direction. The ½-vector detection unit 72 supplies the detected forward motion vector with ½-pixel precision to the ¼-vector detection unit 73.

In step S74, based on the forward motion vector with ½-pixel precision supplied from the ½-vector detection unit 72, the ¼-vector detection unit 73 performs interpolations on the forward reference image. By this, the ¼-vector detection unit 73 generates a forward reference block of 3×3 pixels with the position corresponding to the motion vector being at the center thereof and with intervals in the horizontal and vertical directions being in a ¼ pixel position.

In step S75, as with the integer vector detection unit 71, using the generated forward reference block, the backward reference block, and the encoding target image, the ¼-vector detection unit 73 detects a forward motion vector with ¼-pixel precision, for each inter prediction mode indicating the Bi-prediction as the prediction direction. The ¼-vector detection unit 73 supplies the detected forward motion vector with ¼-pixel precision to the integer vector detection unit 74 and the ¼-vector detection unit 76.

In step S76, based on the forward motion vector with ¼-pixel precision supplied from the ¼-vector detection unit 73, the integer vector detection unit 74 performs interpolations on the forward reference image. By this, the integer vector detection unit 74 generates a forward reference block of 3×3 pixels with the position corresponding to the motion vector being at the center thereof and with intervals in the horizontal and vertical directions being in a ¼ pixel position.

In step S77, as with the integer vector detection unit 71, using the forward reference block, the backward reference image, and the encoding target image, the integer vector detection unit 74 detects a backward motion vector with integer pixel precision, for each inter prediction mode indicating the Bi-prediction as the prediction direction. The integer vector detection unit 74 supplies the detected backward motion vector with integer pixel precision to the ½-vector detection unit 75.

In step S78, based on the backward motion vector with integer pixel precision supplied from the integer vector detection unit 74, the ½-vector detection unit 75 performs interpolations on the backward reference image. By this, the ½-vector detection unit 75 generates a backward reference block of 3×3 pixels with the position corresponding to the motion vector being at the center thereof and with intervals in the horizontal and vertical directions being in a ½ pixel position.

In step S79, as with the integer vector detection unit 71, using the generated backward reference block, the forward reference block, and the encoding target image, the ½-vector detection unit 75 detects a backward motion vector with ½-pixel precision, for each inter prediction mode indicating the Bi-prediction as the prediction direction. The ½-vector detection unit 72 supplies the detected backward motion vector with ½-pixel precision to the ¼-vector detection unit 76.

In step S80, based on the backward motion vector with ½-pixel precision supplied from the ½-vector detection unit 75, the ¼-vector detection unit 76 performs interpolations on the backward reference image. By this, the ¼-vector detection unit 76 generates a backward reference block of 3×3 pixels with the position corresponding to the motion vector being at the center thereof and with intervals in the horizontal and vertical directions being in a ¼ pixel position.

In step S81, as with the integer vector detection unit 71, using the generated backward reference block, the forward reference block, and the encoding target image, the ¼-vector detection unit 76 detects a backward motion vector with ¼-pixel precision, for each inter prediction mode indicating the Bi-prediction as the prediction direction.

In step S82, using the forward motion vector with ¼-pixel precision detected in step S75 and the backward motion vector with ¼-pixel precision detected in step S81 for each inter prediction mode indicating the Bi-prediction as the prediction direction, and the like, the ¼-vector detection unit 76 determines a cost function value for the inter prediction mode. The ¼-vector detection unit 76 then determines the inter prediction mode with the smallest cost function value to be an optimum bidirectional inter prediction mode. The ¼-vector detection unit 76 supplies the optimum bidirectional inter prediction mode, the corresponding cost function value, and the corresponding motion vector to the determination unit 44, and the operation comes to an end.

Note that although the bidirectional motion detection unit 43 of the motion prediction unit 25 shown in FIG. 2 performs each of detection of a forward motion vector with ¼-pixel precision with the backward motion vector with ¼-pixel precision fixed and detection of a backward motion vector with ¼-pixel precision with the forward motion vector with ¼-pixel precision fixed, one time, each detection may be repeated a predetermined number of times.

As described above, the encoding device 10 sets the precision of the motion vector for when the prediction direction is the Bi-prediction to be lower than the precision of the motion vector for when the prediction direction is the L0 prediction or the L1 prediction. Specifically, the precision of the motion vector for when the number of motion vectors per prediction block is large is set to be lower than the precision of the motion vector for when the number of motion vectors per prediction block is small. Accordingly, the precision of the motion compensation operation can be improved while the amount of information on motion vectors is suppressed. As a result, encoding efficiency can be improved.

[Example Structure of a Decoding Device]

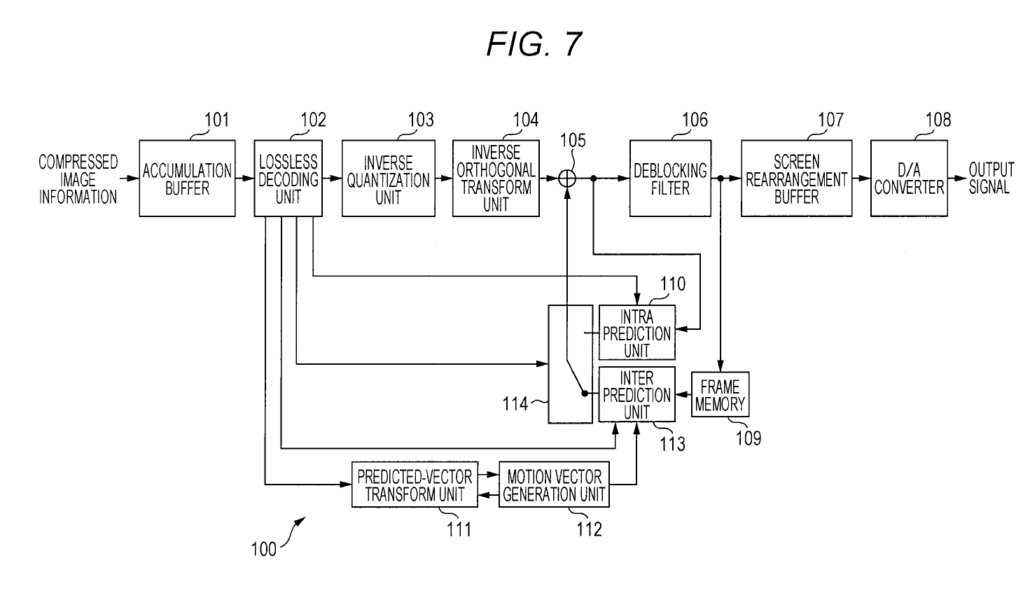

FIG. 7 is a block diagram showing an example structure of a decoding device to which the present technique is applied and which decodes compressed image information output from the encoding device 10 shown in FIG. 1.

The decoding device 100 shown in FIG. 7 includes an accumulation buffer 101, a lossless decoding unit 102, an inverse quantization unit 103, an inverse orthogonal transform unit 104, an addition unit 105, a deblocking filter 106, a screen rearrangement buffer 107, a D/A converter 108, a frame memory 109, an intra prediction unit 110, an inter prediction unit 113, a predicted-vector transform unit 111, a motion vector generation unit 112, and a switch 114.

The accumulation buffer 101 of the decoding device 100 receives and accumulates compressed image information from the encoding device 10 shown in FIG. 1. The accumulation buffer 101 supplies the accumulated compressed image information to the lossless decoding unit 102.

The lossless decoding unit 102 obtains quantized coefficients and a header by performing lossless decoding such as variable-length decoding or arithmetic decoding on the compressed image information supplied from the accumulation buffer 101. The lossless decoding unit 102 supplies the quantized coefficients to the inverse quantization unit 103. The lossless decoding unit 102 also supplies intra prediction mode information and the like which are contained in the header to the intra prediction unit 110. The lossless decoding unit 102 further decomposes difference vector information contained in the header into a sign and an exponential-Golomb code of the absolute value of a difference vector, and inversely binarizes the exponential-Golomb code and then adds the sign to the resultant exponential-Golomb code, to generate a difference vector.

The lossless decoding unit 102 supplies the generated difference vector, and pmv selection information and detected-precision information which are contained in the header, to the predicted-vector transform unit 111. The lossless decoding unit 102 also supplies inter prediction mode information contained in the header to the inter prediction unit 113. The lossless decoding unit 102 further supplies the intra prediction mode information or the inter prediction mode information contained in the header to the switch 114.

The inverse quantization unit 103, the inverse orthogonal transform unit 104, the addition unit 105, the deblocking filter 106, the frame memory 109, the intra prediction unit 110, and the inter prediction unit 113 perform the same operations as the inverse quantization unit 18, the inverse orthogonal transform unit 19, the addition unit 20, the deblocking filter 21, the frame memory 22, the intra prediction unit 23, and the inter prediction unit 24 shown in FIG. 1, to decode images.

Specifically, the inverse quantization unit 103 inversely quantizes the quantized coefficients supplied from the lossless decoding unit 102, and supplies the resultant coefficients to the inverse orthogonal transform unit 104.

The inverse orthogonal transform unit 104 performs an inverse orthogonal transform such as an inverse discrete cosine transform or an inverse Karhunen-Loeve transform on the coefficients supplied from the inverse quantization unit 103, and supplies the resultant residual error information to the addition unit 105.

The addition unit 105 functions as a decoding unit, and performs decoding by adding the residual error information supplied from the inverse orthogonal transform unit 104 and serving as a decoding target image to an predicted image supplied from the switch 114. The addition unit 105 supplies the image obtained as a result of the decoding to the deblocking filter 106, and also supplies the image as a reference image to the intra prediction unit 110. If there are no predicted images supplied from the switch 114, the addition unit 105 supplies an image that is the residual error information supplied from the inverse orthogonal transform unit 104, to the deblocking filter 106, and also supplies the image as a reference image to the intra prediction unit 110.

The deblocking filter 106 performs filtering on the image supplied from the addition unit 105, to remove block distortions. The deblocking filter 106 supplies and stores the resultant image into the frame memory 109, and also supplies the resultant image to the screen rearrangement buffer 107. The image stored in the frame memory 109 is supplied as a reference image to the inter prediction unit 113.

The screen rearrangement buffer 107 stores the image supplied from the deblocking filter 106 frame by frame. The screen rearrangement buffer 107 rearranges the frames of the stored image in the original displaying order, instead of the encoding order, and supplies the rearranged image to the D/A converter 108.

The D/A converter 108 performs a D/A conversion on the frame-based image supplied from the screen rearrangement buffer 107, and outputs an output signal.

Using the reference image supplied from the addition unit 105, the intra prediction unit 110 performs an intra prediction in the intra prediction mode indicated by the intra prediction mode information supplied from the lossless decoding unit 102, and generates a predicted image. The intra prediction unit 110 then supplies the predicted image to the switch 114.

The predicted-vector transform unit 111 reads, from among the stored motion vectors, a motion vector indicated by the pmv selection information supplied from the lossless decoding unit 102, as a predicted vector. When the precision of the difference vector is lower than the precision of the predicted vector, i.e., when the precision of the difference vector is ¼-pixel precision and the precision of the predicted vector is ⅛-pixel precision, according to the detected-precision information supplied from the lossless decoding unit 102, the predicted-vector transform unit 111 performs a rounding operation on the predicted vector to generate a predicted vector with ¼-pixel precision. The predicted-vector transform unit 111 supplies the generated predicted vector with ¼-pixel precision or the read predicted vector itself and the difference vector to the motion vector generation unit 112.

The motion vector generation unit 112 adds the predicted vector and the difference vector which are supplied from the predicted-vector transform unit 111, to generate a motion vector. The motion vector generation unit 112 supplies and stores the generated motion vector into the predicted-vector transform unit 111, and also supplies the generated motion vector to the inter prediction unit 113.

Based on the motion vector supplied from the motion vector generation unit 112 and the inter prediction mode information supplied from the lossless decoding unit 102, as with the inter prediction unit 24 shown in FIG. 1, the inter prediction unit 113 reads a reference image from the frame memory 109. Based on the motion vector and the reference image read from the frame memory 109, the inter prediction unit 113 performs the same inter prediction operation as the inter prediction unit 24. The inter prediction unit 113 supplies the resultant predicted image to the switch 114.

When the intra prediction mode information is supplied from the lossless decoding unit 102, the switch 114 supplies the predicted image supplied from the intra prediction unit 110 to the addition unit 105. When the inter prediction mode information is supplied from the lossless decoding unit 102, on the other hand, the switch 114 supplies the predicted image supplied from the inter prediction unit 113 to the addition unit 105.

[Description of an Operation of the Decoding Device]

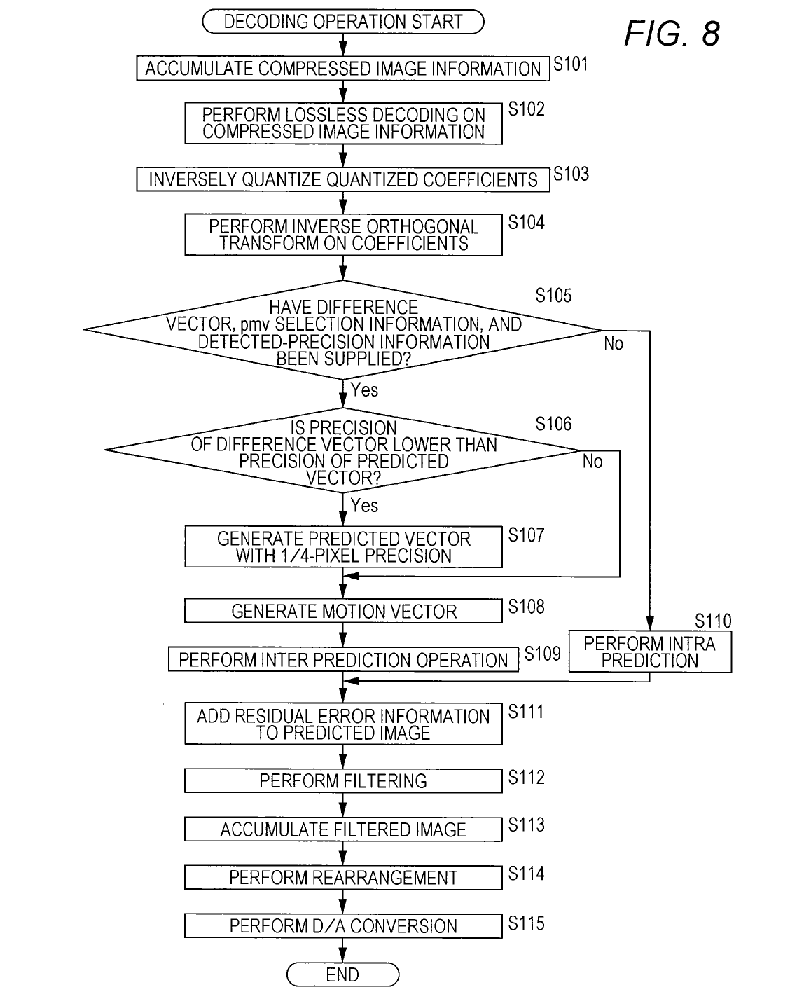

FIG. 8 is a flowchart for explaining a decoding operation by the decoding device 100 shown in FIG. 7. This decoding operation is performed every time frame-based compressed image information is input to the decoding device 100, for example.

In step S101 of FIG. 8, the accumulation buffer 101 of the decoding device 100 receives and accumulates frame-based compressed image information from the encoding device 10 shown in FIG. 1. The accumulation buffer 101 supplies the accumulated compressed image information to the lossless decoding unit 102. Note that the procedures of the following steps S102 to S113 are performed on a CU-by-CU basis, for example.

In step S102, the lossless decoding unit 102 performs lossless decoding on the compressed image information supplied from the accumulation buffer 101, to obtain quantized coefficients and a header. The lossless decoding unit 102 supplies the quantized coefficients to the inverse quantization unit 103. The lossless decoding unit 102 also supplies intra prediction mode information and the like which are contained in the header to the intra prediction unit 110. The lossless decoding unit 102 further decomposes difference vector information contained in the header into a sign and an exponential-Golomb code of the absolute value of a difference vector, and inversely binarizes the exponential-Golomb code and then adds the sign to the resultant exponential-Golomb code, to generate a difference vector.

The lossless decoding unit 102 supplies the generated difference vector, and pmv selection information and detected-precision information which are contained in the header, to the predicted-vector transform unit 111. The lossless decoding unit 102 also supplies inter prediction mode information contained in the header to the inter prediction unit 113. The lossless decoding unit 102 further supplies the intra prediction mode information or the inter prediction mode information contained in the header to the switch 114.

In step S103, the inverse quantization unit 103 inversely quantizes the quantized coefficients supplied from the lossless decoding unit 102, and supplies the resultant coefficients to the inverse orthogonal transform unit 104.

In step S104, the inverse orthogonal transform unit 104 performs an inverse orthogonal transform on the coefficients supplied from the inverse quantization unit 103, and supplies the resultant residual error information to the addition unit 105.

In step S105, the predicted-vector transform unit 111 determines whether a difference vector, pmv selection information, and detected-precision information have been supplied from the lossless decoding unit 102. If it is determined in step S105 that a difference vector, pmv selection information, and detected-precision information have been supplied, the predicted-vector transform unit 111 reads, from among the stored motion vectors, a motion vector indicated by the pmv selection information supplied from the lossless decoding unit 102, as a predicted vector. The operation then moves on to step S106.

In step S106, the predicted-vector transform unit 111 determines according to the detected-precision information supplied from the lossless decoding unit 102 whether the precision of the difference vector is lower than the precision of the predicted vector. When the precision of the difference vector is ¼-pixel precision and the precision of the predicted vector is ⅛-pixel precision, it is determined in step S106 that the precision of the difference vector is lower than the precision of the predicted vector, and the operation moves on to step S107.

In step S107, the predicted-vector transform unit 111 performs a rounding operation on the predicted vector to generate a predicted vector with ¼-pixel precision, and supplies the predicted vector and the difference vector to the motion vector generation unit 112. The operation then moves on to step S108.

When the precision of both of the difference vector and the predicted vector is ¼-pixel precision or ⅛-pixel precision, on the other hand, it is determined in step S106 that the precision of the difference vector is not lower than the precision of the predicted vector. The predicted-vector transform unit 111 then supplies the read predicted vector itself and the difference vector to the motion vector generation unit 112, and the operation moves on to step S108.

In step S108, the motion vector generation unit 112 adds the predicted vector and the difference vector which are supplied from the predicted-vector transform unit 111, to generate a motion vector. The motion vector generation unit 112 supplies and stores the generated motion vector into the predicted-vector transform unit 111, and also supplies the generated motion vector to the inter prediction unit 113.

In step S109, based on the motion vector supplied from the motion vector generation unit 112 and the inter prediction mode information supplied from the lossless decoding unit 102, the inter prediction unit 113 performs the same inter prediction operation as the inter prediction unit 24 shown in FIG. 1. The inter prediction unit 113 supplies the resultant predicted image to the addition unit 105 via the switch 114, and the operation then moves on to step S111.

If it is determined in step S105 that a difference vector, pmv selection information, and detected-precision information have not been supplied, i.e., if the intra prediction mode information is supplied to the intra prediction unit 110, on the other hand, the operation moves on to step S110.

In step S110, using a reference image supplied from the addition unit 105, the intra prediction unit 110 performs an intra prediction in the intra prediction mode indicated by the intra prediction mode information supplied from the lossless decoding unit 102. The intra prediction unit 110 then supplies the resultant predicted image to the addition unit 105 via the switch 114, and the operation then moves on to step S111.

In step S111, the addition unit 105 adds the residual error information supplied from the inverse orthogonal transform unit 104 to the predicted image supplied from the switch 114. The addition unit 105 supplies the resultant image to the deblocking filter 106, and also supplies the resultant image as a reference image to the intra prediction unit 110.

In step S112, the deblocking filter 106 performs filtering on the image supplied from the addition unit 105, to remove block distortions.

In step S113, the deblocking filter 106 supplies and stores the filtered image into the frame memory 109, and also supplies the filtered image to the screen rearrangement buffer 107. The image stored in the frame memory 109 is supplied as a reference image to the inter prediction unit 113.

In step S114, the screen rearrangement buffer 107 stores the image supplied from the deblocking filter 106 frame by frame, rearranges the frames of the stored image in the original displaying order, instead of the encoding order, and supplies the rearranged image to the D/A converter 108.

In step S115, the D/A converter 108 performs a D/A conversion on the frame-based image supplied from the screen rearrangement buffer 107, and outputs an output signal.

As described above, when the precision of a difference vector is ¼-pixel precision and the precision of a predicted vector is ⅛-pixel precision according to detected-precision information, the decoding device 100 performs a rounding operation on the predicted vector to generate a predicted vector with ¼-pixel precision. Therefore, in the encoding device 10, by setting the precision of the motion vector for when the number of motion vectors per prediction block is large to be lower than the precision of the motion vector for when the number of motion vectors per prediction block is small, compressed image information which is encoded so as to improve encoding efficiency can be decoded.

Note that although in the present embodiment the precision of the motion vector is switched depending on whether the prediction direction is the L0 prediction or the L1 prediction, or the Bi-prediction, the switching method is not limited thereto as long as the precision of the motion vector can be switched between when the number of motion vectors is large and when the number of motion vectors is small. For example, when the size of the prediction block for inter prediction is small, the precision of the motion vector can also be set to be lower than that for when the size of the prediction block is large. In addition, when the prediction direction is the Bi-prediction or the size of the prediction block for inter prediction is small, the precision of the motion vector can also be set to be lower than that for when the prediction direction is the L0 prediction or the L1 prediction and the size of the prediction block is large.

In addition, although in the present embodiment the absolute value of the difference vector is binarized using an exponential-Golomb code, the code used for binarization may be any other code than the exponential-Golomb code.

Further, although in the present embodiment, when the prediction direction is the Bi-prediction, the precision of motion vectors for all reference images is set to be lower than that for when the prediction direction is the L0 prediction or the L1 prediction, only the precision of motion vectors for some reference images may be set to be lower. In this case, detected-precision information is set for each reference image.

In addition, although in the present embodiment the precision of the motion vector is switched to ¼-pixel precision or ⅛-pixel precision, the precision of the motion vector is not limited thereto. The precision of the motion vector may be switched to ¼-pixel precision or 1/16-pixel precision, for example.

<Description of a Computer to which the Present Technique is Applied>

The above described encoding operation and decoding operation can be performed with hardware, and can also be performed with software. Where encoding operations and decoding operations are performed with software, a program that forms the software is installed into a general-purpose computer or the like.

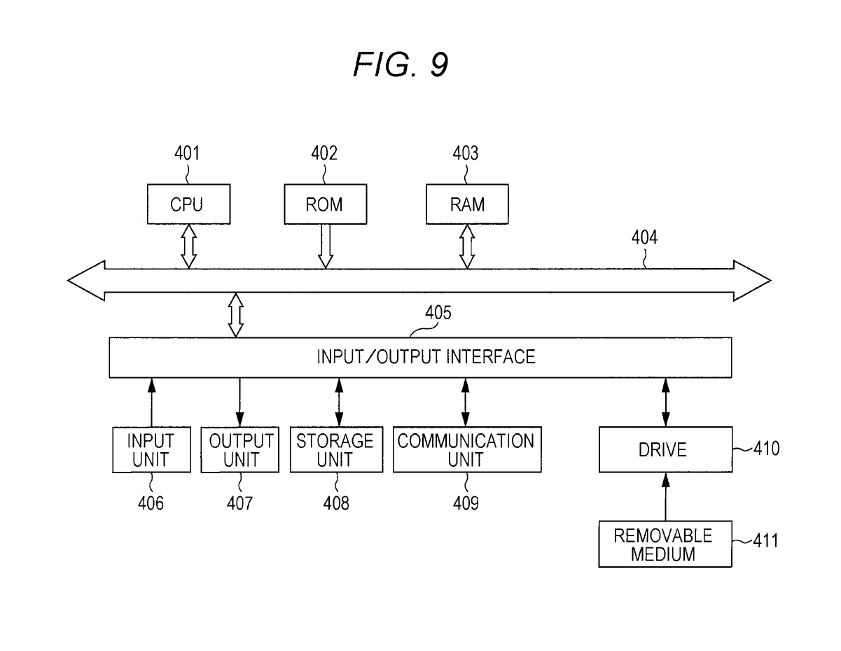

In view of this, FIG. 9 shows an example structure of an embodiment of a computer into which the program for performing the above described series of operations is installed.

The program can be recorded beforehand in a storage unit 408 or a ROM (Read Only Memory) 402 provided as a recording medium in the computer.

Alternatively, the program can be stored (recorded) in a removable medium 411. Such a removable medium 411 can be provided as so-called packaged software. Here, the removable medium 411 may be a flexible disk, a CD-ROM (Compact Disc Read Only Memory), MO (Magneto Optical) disk, a DVD (Digital Versatile Disc), a magnetic disk, or a semiconductor memory, for example.

The program can be installed into the computer from the above described removable medium. 411 via a drive 410, but can also be downloaded into the computer via a communication network or a broadcasting network and be installed into the internal storage unit 408. That is, the program can be wirelessly transferred from a download site, for example, to the computer via an artificial satellite for digital satellite broadcasting, or can be transferred by cable to the computer via a network such as a LAN (Local Area Network) or the Internet.

The computer includes a CPU (Central Processing Unit) 401, and an input/output interface 405 is connected to the CPU 401 via a bus 404.

When an instruction is input by a user operating an input unit 406 or the like via the input/output interface 405, the CPU 401 executes the program stored in the ROM 402 accordingly. Alternatively, the CPU 401 loads the program stored in the storage unit 408 into a RAM (Random Access Memory) 403, and executes the program.

By doing so, the CPU 401 performs the operations according to the above described flowcharts, or performs the operations with the structures illustrated in the above described block diagrams. Where necessary, the CPU 401 outputs the operation results from an output unit 407 or transmit the operation results from a communication unit 409, via the input/output interface 405, for example, and further stores the operation results into the storage unit 408.

The input unit 406 is formed with a keyboard, a mouse, a microphone, and the like. The output unit 407 is formed with an LCD (Liquid Crystal Display), a speaker, and the like.

In this specification, the processes performed by the computer in accordance with the program are not necessarily performed in chronological order compliant with the sequences shown in the flowcharts. That is, the processes to be performed by the computer in accordance with the program include processes to be performed in parallel or independently of one another (such as parallel processes or object-based processes).

The program may be executed by one computer (processor), or may be executed in a distributive manner by more than one computer. Further, the program may be transferred to a remote computer, and be executed therein.

<Example Structure of a Television Receiver>

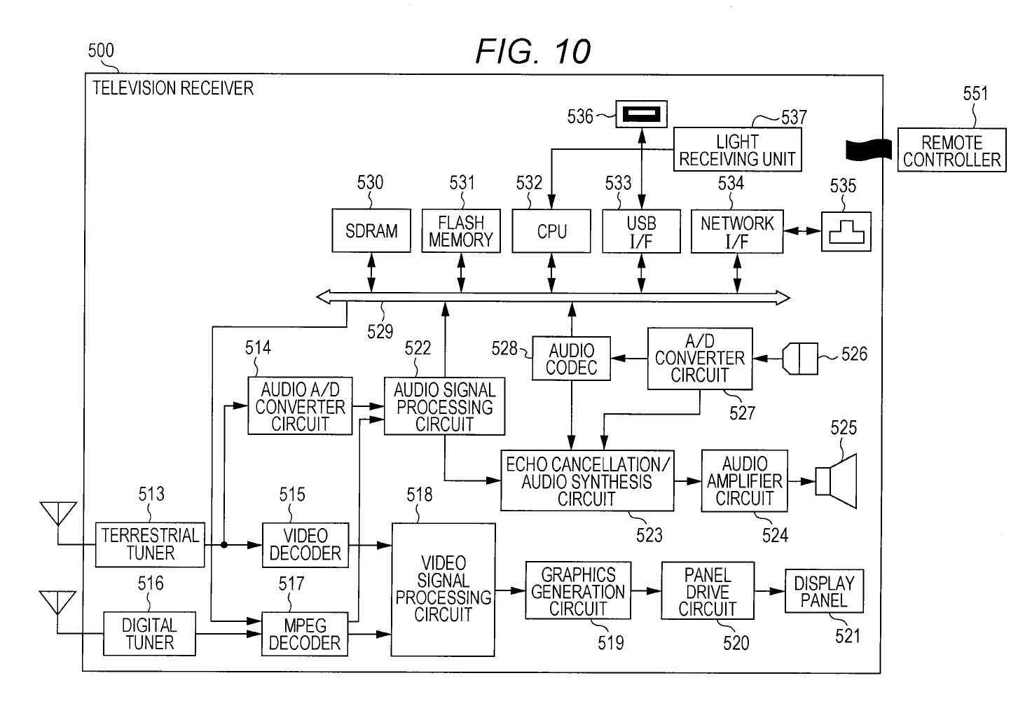

FIG. 10 is a block diagram showing a typical example structure of a television receiver using a decoding device to which the present technique is applied.

The television receiver 500 shown in FIG. 10 includes a terrestrial tuner 513, a video decoder 515, a video signal processing circuit 518, a graphics generation circuit 519, a panel drive circuit 520, and a display panel 521.

The terrestrial tuner 513 receives a broadcast wave signal of analog terrestrial broadcasting via an antenna, and demodulates the signal to obtain a video signal. The terrestrial tuner 513 supplies the video signal to the video decoder 515. The video decoder 515 performs a decoding operation on the video signal supplied from the terrestrial tuner 513, and supplies the resultant digital component signal to the video signal processing circuit 518.

The video signal processing circuit 518 performs predetermined processing such as denoising on the video data supplied from the video decoder 515, and supplies the resultant video data to the graphics generation circuit 519.

The graphics generation circuit 519 generates video data of a show to be displayed on the display panel 521, or generates image data by performing an operation based on an application supplied via a network. The graphics generation circuit 519 supplies the generated video data or image data to the panel drive circuit 520. The graphics generation circuit 519 also generates video data (graphics) for displaying a screen to be used by a user to select an item, and superimposes the video data on the video data of the show. The resultant video data is supplied to the panel drive circuit 520 where appropriate.

Based on the data supplied from the graphics generation circuit 519, the panel drive circuit 520 drives the display panel 521, and causes the display panel 521 to display the video image of the show and each screen described above.

The display panel 521 is formed with an LCD (Liquid Crystal Display) or the like, and displays the video image of a show or the like under the control of the panel drive circuit 520.

The television receiver 500 also includes an audio A/D (Analog/Digital) converter circuit 514, an audio signal processing circuit 522, an echo cancellation/audio synthesis circuit 523, an audio amplifier circuit 524, and a speaker 525.

The terrestrial tuner 513 obtains not only a video signal but also an audio signal by demodulating a received broadcast wave signal. The terrestrial tuner 513 supplies the obtained audio signal to the audio A/D converter circuit 514.

The audio A/D converter circuit 514 performs an A/D converting operation on the audio signal supplied from the terrestrial tuner 513, and supplies the resultant digital audio signal to the audio signal processing circuit 522.

The audio signal processing circuit 522 performs predetermined processing such as denoising on the audio data supplied from the audio A/D converter circuit 514, and supplies the resultant audio data to the echo cancellation/audio synthesis circuit 523.

The echo cancellation/audio synthesis circuit 523 supplies the audio data supplied from the audio signal processing circuit 522 to the audio amplifier circuit 524.

The audio amplifier circuit 524 performs a D/A converting operation and an amplifying operation on the audio data supplied from the echo cancellation/audio synthesis circuit 523. After adjusted to a predetermined sound level, the sound is output from the speaker 525.

The television receiver 500 further includes a digital tuner 516 and an MPEG decoder 517.

The digital tuner 516 receives a broadcast wave signal of digital broadcasting (digital terrestrial broadcasting or digital BS (Broadcasting Satellite)/CS (Communications Satellite) broadcasting) via the antenna, and demodulates the broadcast wave signal, to obtain an MPEG-TS (Moving Picture Experts Group-Transport Stream). The MPEG-TS is supplied to the MPEG decoder 517.

The MPEG decoder 517 descrambles the MPEG-TS supplied from the digital tuner 516, and extracts the stream containing the data of the show to be reproduced (to be viewed). The MPEG decoder 517 decodes the audio packet forming the extracted stream, and supplies the resultant audio data to the audio signal processing circuit 522. The MPEG decoder 517 also decodes the video packet forming the stream, and supplies the resultant video data to the video signal processing circuit 518. The MPEG decoder 517 also supplies EPG (Electronic Program Guide) data extracted from the MPEG-TS to a CPU 532 via a path (not shown).

The television receiver 500 uses the above described decoding device 100 as the MPEG decoder 517, which decodes the video packet as described above. Therefore, in the MPEG decoder 517, as is the case of the decoding device 100, when a motion compensation operation with fractional precision is performed upon inter prediction, an image encoded so as to improve encoding efficiency can be decoded.

The video data supplied from the MPEG decoder 517 is subjected to predetermined processing at the video signal processing circuit 518, as in the case of the video data supplied from the video decoder 515. At the graphics generation circuit 519, generated video data and the like are superimposed on the video data subjected to the predetermined processing, where appropriate. The resultant video data is supplied to the display panel 521 via the panel drive circuit 520, and the image is displayed.

The audio data supplied from the MPEG decoder 517 is subjected to predetermined processing at the audio signal processing circuit 522, as in the case of the audio data supplied from the audio A/D converter circuit 514. The audio data subjected to the predetermined processing is supplied to the audio amplifier circuit 524 via the echo cancellation/audio synthesis circuit 523, and is subjected to a D/A converting operation or an amplifying operation. As a result, a sound that is adjusted to a predetermined sound level is output from the speaker 525.

The television receiver 500 also includes a microphone 526 and an A/D converter circuit 527.

The A/D converter circuit 527 receives a signal of a user's voice captured by the microphone 526 provided for voice conversations in the television receiver 500. The A/D converter circuit 527 performs an A/D converting operation on the received audio signal, and supplies the resultant digital audio data to the echo cancellation/audio synthesis circuit 523.

When audio data of a user (a user A) of the television receiver 500 is supplied from the A/D converter circuit 527, the echo cancellation/audio synthesis circuit 523 performs echo cancellation on the audio data of the user A. After the echo cancellation, the echo cancellation/audio synthesis circuit 523 then combines the audio data with other audio data or the like, and causes the speaker 525 to output the resultant audio data via the audio amplifier circuit 524.

The television receiver 500 further includes an audio codec 528, an internal bus 529, an SDRAM (Synchronous Dynamic Random Access Memory) 530, a flash memory 531, the CPU 532, a USB (Universal Serial Bus) I/F 533, and a network I/F 534.

The A/D converter circuit 527 receives a signal of a user's voice captured by the microphone 526 provided for voice conversations in the television receiver 500. The A/D converter circuit 527 performs an A/D converting operation on the received audio signal, and supplies the resultant digital audio data to the audio codec 528.

The audio codec 528 transforms the audio data supplied from the A/D converter circuit 527 into data in a predetermined format for transmission via a network, and supplies the resultant data to the network I/F 534 via the internal bus 529.

The network I/F 534 is connected to a network via a cable attached to a network terminal 535. The network I/F 534 transmits the audio data supplied from the audio codec 528 to another device connected to the network, for example. The network I/F 534 also receives, via the network terminal 535, audio data transmitted from another device connected via the network, and supplies the audio data to the audio codec 528 via the internal bus 529.

The audio codec 528 transforms the audio data supplied from the network I/F 534 into data in a predetermined format, and supplies the resultant data to the echo cancellation/audio synthesis circuit 523.

The echo cancellation/audio synthesis circuit 523 performs echo cancellation on the audio data supplied from the audio codec 528, and combines the audio data with other audio data or the like. The resultant audio data is output from the speaker 525 via the audio amplifier circuit 524.

The SDRAM 530 stores various kinds of data necessary for the CPU 532 to perform processing.

The flash memory 531 stores the program to be executed by the CPU 532. The program stored in the flash memory 531 is read by the CPU 532 at a predetermined time, such as when the television receiver 500 is activated. The flash memory 531 also stores EPG data obtained through digital broadcasting, data obtained from a predetermined server via a network, and the like.

For example, the flash memory 531 stores an MPEG-TS containing content data obtained from a predetermined server via a network, under the control of the CPU 532. The flash memory 531 supplies the MPEG-TS to the MPEG decoder 517 via the internal bus 529, under the control of the CPU 532, for example.

The MPEG decoder 517 processes the MPEG-TS, as in the case of the MPEG-TS supplied from the digital tuner 516. In this manner, the television receiver 500 receives the content data formed with a video image and a sound via the network, and decodes the content data by using the MPEG decoder 517, to display the video image and output the sound.

The television receiver 500 also includes a light receiving unit 537 that receives an infrared signal transmitted from a remote controller 551.

The light receiving unit 537 receives an infrared ray from the remote controller 551, and performs demodulation. The light receiving unit 537 outputs a control code indicating the contents of a user operation obtained through the demodulation, to the CPU 532.

The CPU 532 executes the program stored in the flash memory 531, and controls the entire operation of the television receiver 500 in accordance with the control code and the like supplied from the light receiving unit 537. The respective components of the television receiver 500 are connected to the CPU 532 via a path (not shown).

The USB I/F 533 exchanges data with an apparatus that is located outside the television receiver 500 and is connected thereto via a USB cable attached to a USB terminal 536. The network I/F 534 is connected to the network via the cable attached to the network terminal 535, and also exchanges data other than audio data with various kinds of devices connected to the network.

By using the decoding device 100 as the MPEG decoder 517, when a motion compensation operation with fractional precision is performed upon inter prediction, the television receiver 500 can decode an image encoded so as to improve encoding efficiency.

<Example Structure of a Portable Telephone Device>

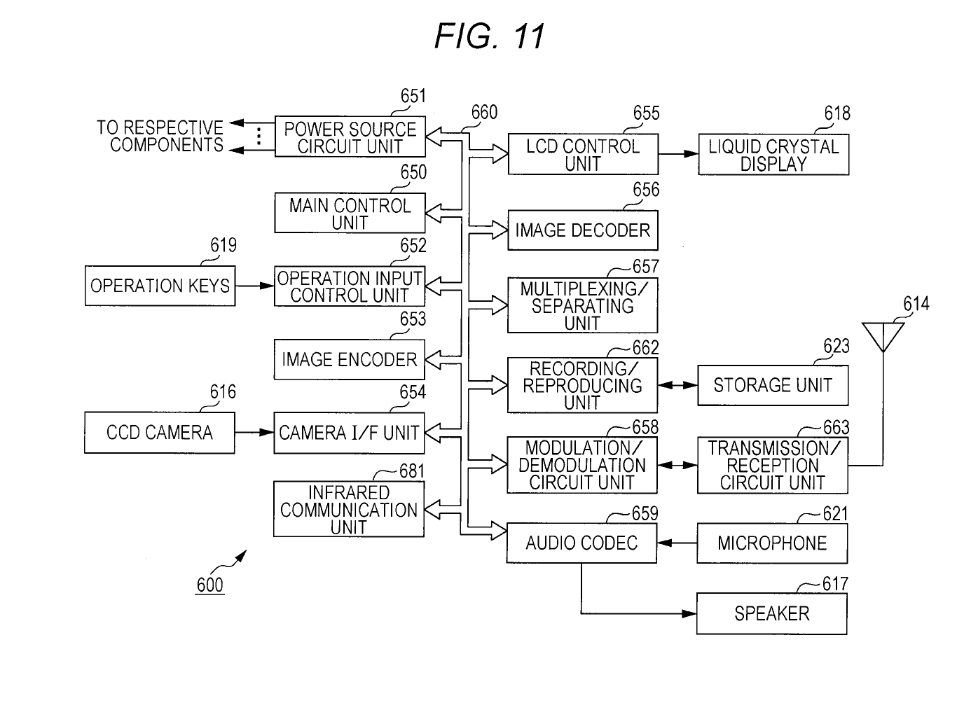

FIG. 11 is a block diagram showing a typical example structure of a portable telephone device using an encoding device and a decoding device to which the present technique is applied.

The portable telephone device 600 shown in FIG. 11 includes a main control unit 650 designed to collectively control respective components, a power source circuit unit 651, an operation input control unit 652, an image encoder 653, a camera I/F unit 654, an LCD control unit 655, an image decoder 656, a multiplexing/separating unit 657, a recording/reproducing unit 662, a modulation/demodulation circuit unit 658, and an audio codec 659. Those components are connected to one another via a bus 660.

The portable telephone device 600 also includes operation keys 619, a CCD (Charge Coupled Device) camera 616, a liquid crystal display 618, a storage unit 623, a transmission/reception circuit unit 663, an antenna 614, a microphone (mike) 621, and a speaker 617.

When a call is ended or the power key is switched on by a user's operation, the power source circuit unit 651 puts the portable telephone device 600 into an operable state by supplying power from a battery pack to the respective components.

Under the control of the main control unit 650 formed with a CPU, a ROM, a RAM, and the like, the portable telephone device 600 performs various kinds of operations, such as transmission and reception of audio signals, transmission and reception of electronic mail and image data, image capturing, and data recording, in various kinds of modes such as a voice communication mode and a data communication mode.

In the portable telephone device 600 in the voice communication mode, for example, an audio signal captured by the microphone (mike) 621 is transformed into digital audio data by the audio codec 659, and the digital audio data is subjected to spread spectrum processing at the modulation/demodulation circuit unit 658. The resultant data is then subjected to a digital-analog converting operation and a frequency converting operation at the transmission/reception circuit unit 663. The portable telephone device 600 transmits the transmission signal obtained through the converting operations to a base station (not shown) via the antenna 614. The transmission signal (audio signal) transmitted to the base station is further supplied to the portable telephone device at the other end of the communication via a public telephone line network.

Also, in the portable telephone device 600 in the voice communication mode, for example, a reception signal received by the antenna 614 is amplified at the transmission/reception circuit unit 663, and is further subjected to a frequency converting operation and an analog-digital converting operation. The resultant signal is subjected to inverse spread spectrum processing at the modulation/demodulation circuit unit 658, and is transformed into an analog audio signal by the audio codec 659. The portable telephone device 600 outputs, from the speaker 617, the analog audio signal obtained through the conversions.

Further, when electronic mail is transmitted in the data communication mode, for example, the operation input control unit 652 of the portable telephone device 600 receives text data of the electronic mail that is input by operating the operation keys 619. The portable telephone device 600 processes the text data at the main control unit 650, and displays the text data as an image on the liquid crystal display 618 via the LCD control unit 655.

In the portable telephone device 600, the main control unit 650 generates electronic mail data, based on text data, a user's instruction, or the like received by the operation input control unit 652. The portable telephone device 600 subjects the electronic mail data to spread spectrum processing at the modulation/demodulation circuit unit 658, and to a digital-analog converting operation and a frequency converting operation at the transmission/reception circuit unit 663. The portable telephone device 600 transmits the transmission signal obtained through the converting operations to a base station (not shown) via the antenna 614. The transmission signal (electronic mail) transmitted to the base station is supplied to a predetermined address via a network, a mail server, and the like.

When electronic mail is received in the data communication mode, for example, the transmission/reception circuit unit 663 of the portable telephone device 600 receives a signal transmitted from a base station via the antenna 614, and the signal is amplified and is further subjected to a frequency converting operation and an analog-digital converting operation. The portable telephone device 600 subjects the received signal to inverse spread spectrum processing at the modulation/demodulation circuit unit 658, to restore the original electronic mail data. The portable telephone device 600 displays the restored electronic mail data on the liquid crystal display 618 via the LCD control unit 655.

The portable telephone device 600 can also record (store) received electronic mail data into the storage unit 623 via the recording/reproducing unit 662.

The storage unit 623 is a rewritable storage medium. The storage unit 623 may be a semiconductor memory such as a RAM or an internal flash memory, a hard disk, or a removable medium such as a magnetic disk, a magnetooptical disk, an optical disk, a USB memory, or a memory card, for example. It is of course possible to use a memory other than the above.

Further, when image data is transmitted in the data communication mode, for example, the portable telephone device 600 generates the image data at the CCD camera 616 capturing an image. The CCD camera 616 includes optical devices such as a lens and a diaphragm, and a CCD as a photoelectric conversion device. The CCD camera 616 captures an image of an object, converts the intensity of the received light into an electrical signal, and generates image data of the image of the object. The image encoder 653 then performs compression encoding on the image data via the camera I/F unit 654 by using a predetermined encoding method such as MPEG2 or MPEG4. Thus, the image data is converted into encoded image data.

The portable telephone device 600 uses the above described encoding device 10 as the image encoder 653 that performs the above operation. Therefore, as in the case of the encoding device 10, when a motion compensation operation with fractional precision is performed upon inter prediction, the image encoder 653 can improve encoding efficiency.

At the same time as above, in the portable telephone device 600, the sound that is captured by the microphone (mike) 621 during the image capturing by the CCD camera 616 is analog-digital converted at the audio codec 659, and is further encoded.

The multiplexing/separating unit 657 of the portable telephone device 600 multiplexes the encoded image data supplied from the image encoder 653 and the digital audio data supplied from the audio codec 659 by a predetermined method. The portable telephone device 600 subjects the resultant multiplexed data to spread spectrum processing at the modulation/demodulation circuit unit 658, and to a digital-analog converting operation and a frequency converting operation at the transmission/reception circuit unit 663. The portable telephone device 600 transmits the transmission signal obtained through the converting operations to abase station (not shown) via the antenna 614. The transmission signal (image data) transmitted to the base station is supplied to the other end of the communication via a network or the like.

When image data is not transmitted, the portable telephone device 600 can also display image data generated at the CCD camera 616 on the liquid crystal display 618 via the LCD control unit 655, instead of the image encoder 653.

When the data of a moving image file linked to a simplified homepage or the like is received in the data communication mode, for example, the transmission/reception circuit unit 663 of the portable telephone device 600 receives a signal transmitted from a base station via the antenna 614. The signal is amplified, and is further subjected to a frequency converting operation and an analog-digital converting operation. The portable telephone device 600 subjects the received signal to inverse spread spectrum processing at the modulation/demodulation circuit unit 658, to restore the original multiplexed data. The portable telephone device 600 divides the multiplexed data into encoded image data and audio data at the multiplexing/separating unit 657.

By decoding the encoded image data at the image decoder 656 using a decoding method compatible with a predetermined encoding method such as MPEG2 or MPEG4, the portable telephone device 600 generates reproduced moving image data, and displays the reproduced moving image data on the liquid crystal display 618 via the LCD control unit 655. In this manner, the moving image data contained in a moving image file linked to a simplified homepage, for example, is displayed on the liquid crystal display 618.

The portable telephone device 600 uses the above described decoding device 100 as the image decoder 656 that performs the above operation. Therefore, as in the case of the decoding device 100, when a motion compensation operation with fractional precision is performed upon inter prediction, the image decoder 656 can decode an image encoded so as to improve encoding efficiency.

At the same time as above, the portable telephone device 600 transforms the digital audio data into an analog audio signal at the audio codec 659, and outputs the analog audio signal from the speaker 617. In this manner, the audio data contained in a moving image file linked to a simplified homepage, for example, is reproduced.

As in the case of electronic mail, the portable telephone device 600 can also record (store) received data linked to a simplified homepage or the like into the storage unit 623 via the recording/reproducing unit 662.

The main control unit 650 of the portable telephone device 600 can also analyze a two-dimensional code obtained by the CCD camera 616 performing image capturing, and obtain the information recorded in the two-dimensional code.

Further, an infrared communication unit 681 of the portable telephone device 600 can communicate with an external apparatus by using infrared rays.

By using the encoding device 10 as the image encoder 653, when a motion compensation operation with fractional precision is performed upon inter prediction, the portable telephone device 600 can improve encoding efficiency.

By using the decoding device 100 as the image decoder 656, when a motion compensation operation with fractional precision is performed upon inter prediction, the portable telephone device 600 can also decode an image encoded so as to improve encoding efficiency.

In the above description, the portable telephone device 600 uses the CCD camera 616. However, instead of the CCD camera 616, an image sensor (a CMOS image sensor) using a CMOS (Complementary Metal Oxide Semiconductor) may be used. In that case, the portable telephone device 600 can also capture an image of an object, and generate the image data of the image of the object, as in the case where the CCD camera 616 is used.

Although the portable telephone device 600 has been described above, the encoding device 10 and the decoding device 100 can also be applied to any device in the same manner as in the case of the portable telephone device 600, as long as the device has the same image capturing function and the same communication function as the portable telephone device 600. Such a device may be a PDA (Personal Digital Assistant), a smartphone, an UMPC (Ultra Mobile Personal Computer), a netbook, or a notebook personal computer, for example.

<Example Structure of a Hard Disk Recorder>

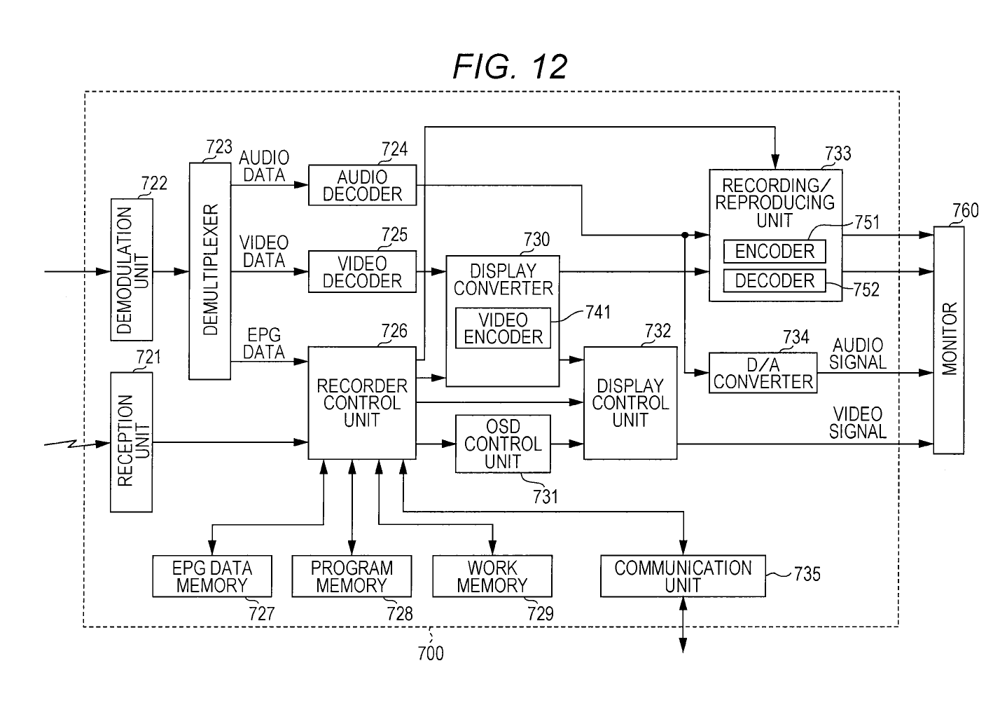

FIG. 12 is a block diagram showing a typical example structure of a hard disk recorder using an encoding device and a decoding device to which the present technique is applied.

The hard disk recorder (a HDD recorder) 700 shown in FIG. 12 is a device that stores, into an internal hard disk, the audio data and the video data of a broadcast show contained in a broadcast wave signal (a television signal) that is transmitted from a satellite or a terrestrial antenna or the like and is received by a tuner, and provides the stored data to a user at a time designated by an instruction from the user.

The hard disk recorder 700 can extract audio data and video data from a broadcast wave signal, for example, decode those data where appropriate, and store the data into an internal hard disk. Also, the hard disk recorder 700 can obtain audio data and video data from another device via a network, for example, decode those data where appropriate, and store the data into an internal hard disk.

Further, the hard disk recorder 700 decodes audio data and video data recorded on an internal hard disk, for example, supplies those data to a monitor 760, and displays the image on the screen of the monitor 760. The hard disk recorder 700 can also output the sound from the speaker of the monitor 760.

The hard disk recorder 700 decodes audio data and video data extracted from a broadcast wave signal obtained via a tuner, or audio data and video data obtained from another device via a network, for example, supplies those data to the monitor 760, and displays the image on the screen of the monitor 760. The hard disk recorder 700 can also output the sound from the speaker of the monitor 760.

The hard disk recorder 700 can of course perform operations other than the above.

As shown in FIG. 12, the hard disk recorder 700 includes a reception unit 721, a demodulation unit 722, a demultiplexer 723, an audio decoder 724, a video decoder 725, and a recorder control unit 726. The hard disk recorder 700 further includes an EPG data memory 727, a program memory 728, a work memory 729, a display converter 730, an OSD (On-Screen Display) control unit 731, a display control unit 732, a recording/reproducing unit 733, a D/A converter 734, and a communication unit 735.

The display converter 730 includes a video encoder 741. The recording/reproducing unit 733 includes an encoder 751 and a decoder 752.

The reception unit 721 receives an infrared signal from a remote controller (not shown), converts the infrared signal into an electrical signal, and outputs the electrical signal to the recorder control unit 726. The recorder control unit 726 is formed with a microprocessor, for example, and performs various kinds of operations in accordance with a program stored in the program memory 728. At this point, the recorder control unit 726 uses the work memory 729 where necessary.

The communication unit 735 is connected to a network, and performs a communication operation with another device via the network. For example, under the control of the recorder control unit 726, the communication unit 735 communicates with a tuner (not shown), and outputs a station select control signal mainly to the tuner.

The demodulation unit 722 demodulates a signal supplied from the tuner, and outputs the signal to the demultiplexer 723. The demultiplexer 723 divides the data supplied from the demodulation unit 722 into audio data, video data, and EPG data. The demultiplexer 723 outputs the audio data, the video data, and the EPG data to the audio decoder 724, the video decoder 725, and the recorder control unit 726, respectively.

The audio decoder 724 decodes the input audio data by an MPEG method, for example, and outputs the decoded audio data to the recording/reproducing unit 733. The video decoder 725 decodes the input video data by the MPEG method, for example, and outputs the decoded video data to the display converter 730. The recorder control unit 726 supplies and stores the input EPG data into the EPG data memory 727.

The display converter 730 encodes video data supplied from the video decoder 725 or the recorder control unit 726 into video data compliant with the NTSC (National Television Standards Committee) standards, for example, using the video encoder 741. The encoded video data is output to the recording/reproducing unit 733. Also, the display converter 730 converts the screen size of video data supplied from the video decoder 725 or the recorder control unit 726 into a size compatible with the size of the monitor 760. The display converter 730 further converts the video data having the converted screen size into video data compliant with the NTSC standards by using the video encoder 741. The NTSC video data is then converted into an analog signal, and is output to the display control unit 732.

Under the control of the recorder control unit 726, the display control unit 732 superimposes an OSD signal output from the OSD (On-Screen Display) control unit 731 on the video signal input from the display converter 730, and outputs the resultant signal to the display of the monitor 760 to display the image.

Audio data that is output from the audio decoder 724 and is converted into an analog signal by the D/A converter 734 is also supplied to the monitor 760. The monitor 760 outputs the audio signal from an internal speaker.

The recording/reproducing unit 733 includes a hard disk as a storage medium for recording video data, audio data, and the like.

The recording/reproducing unit 733 causes the encoder 751 to encode audio data supplied from the audio decoder 724 by an MPEG method, for example. The recording/reproducing unit 733 also causes the encoder 751 to encode video data supplied from the video encoder 741 of the display converter 730 by an MPEG method. The recording/reproducing unit 733 combines the encoded data of the audio data with the encoded data of the video data, using a multiplexer. The recording/reproducing unit 733 amplifies the combined data through channel coding, and writes the resultant data on the hard disk via a recording head.

The recording/reproducing unit 733 reproduces data recorded on the hard disk via a reproduction head, amplifies the data, and divides the data into audio data and video data by using a demultiplexer. The recording/reproducing unit 733 decodes the audio data and the video data by using the decoder 752 by an MPEG method. The recording/reproducing unit 733 performs a D/A conversion on the decoded audio data, and outputs the resultant data to the speaker of the monitor 760. The recording/reproducing unit 733 also performs a D/A conversion on the decoded video data, and outputs the resultant data to the display of the monitor 760.

Based on a user's instruction indicated by an infrared signal that is transmitted from a remote controller and is received via the reception unit 721, the recorder control unit 726 reads the latest EPG data from the EPG data memory 727, and supplies the EPG data to the OSD control unit 731. The OSD control unit 731 generates image data corresponding to the input EPG data, and outputs the image data to the display control unit 732. The display control unit 732 outputs the video data input from the OSD control unit 731 to the display of the monitor 760 to display the image. In this manner, an EPG (Electronic Program Guide) is displayed on the display of the monitor 760.

The hard disk recorder 700 can also obtain various kinds of data, such as video data, audio data, and EPG data, which are supplied from another device via a network such as the Internet.

Under the control of the recorder control unit 726, the communication unit 735 obtains encoded data of video data, audio data, EPG data, and the like transmitted from another device via a network, and supplies those data to the recorder control unit 726. For example, the recorder control unit 726 supplies encoded data of obtained video data and audio data to the recording/reproducing unit 733, and stores those data on the hard disk. At this point, the recorder control unit 726 and the recording/reproducing unit 733 may perform an operation such as re-encoding where necessary.

The recorder control unit 726 also decodes encoded data of obtained video data and audio data, and supplies the resultant video data to the display converter 730. The display converter 730 processes the video data supplied from the recorder control unit 726 in the same manner as processing of video data supplied from the video decoder 725, and supplies the resultant data to the monitor 760 via the display control unit 732 to display the image.

In synchronization with the image display, the recorder control unit 726 may supply the decoded audio data to the monitor 760 via the D/A converter 734, and output the sound from the speaker.

Further, the recorder control unit 726 decodes encoded data of obtained EPG data, and supplies the decoded EPG data to the EPG data memory 727.

The above described hard disk recorder 700 uses the decoding device 100 as the video decoder 725, the decoder 752, and the decoder provided in the recorder control unit 726. Therefore, as in the case of the decoding device 100, when a motion compensation operation with fractional precision is performed upon inter prediction, the video decoder 725, the decoder 752, and the decoder provided in the recorder control unit 726 can decode an image encoded so as to improve encoding efficiency.

The hard disk recorder 700 also uses the encoding device 10 as the encoder 751. Therefore, as in the case of the encoding device 10, when a motion compensation operation with fractional precision is performed upon inter prediction, the encoder 751 can improve encoding efficiency.

In the above description, the hard disk recorder 700 that records video data and audio data on a hard disk has been described. However, any other recording medium may be used. For example, as in the case of the above described hard disk recorder 700, the encoding device 10 and the decoding device 100 can be applied to a recorder that uses a recording medium such as a flash memory, an optical disk, or a videotape, other than a hard disk.

<Example Structure of a Camera>

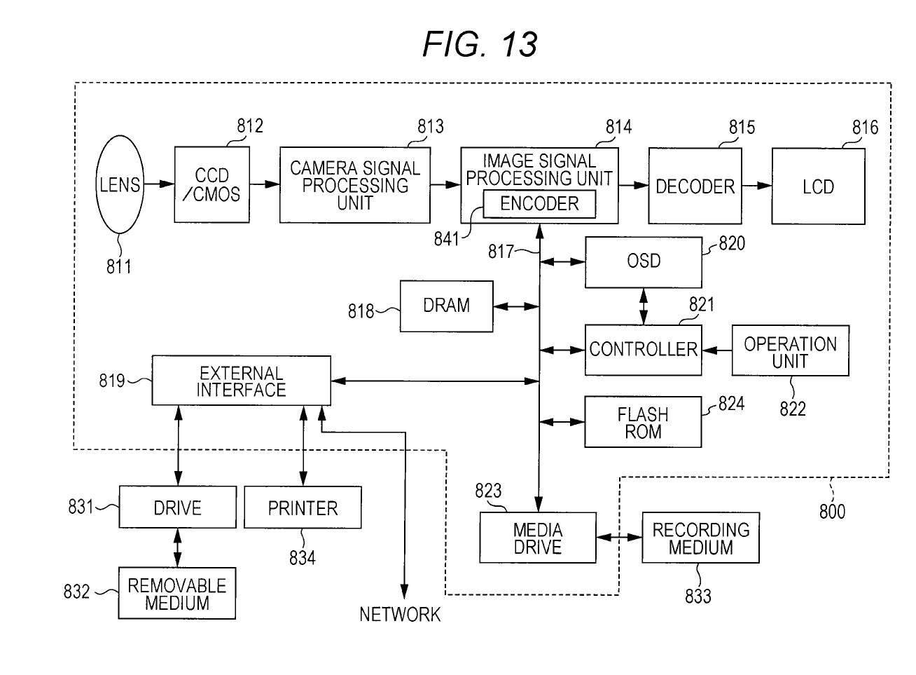

FIG. 13 is a block diagram showing a typical example structure of a camera using an encoding device and a decoding device to which the present technique is applied.

The camera 800 shown in FIG. 13 captures an image of an object, and displays the image of the object on an LCD 816 or records the image of the object as image data on a recording medium 833.

A lens block 811 has light (i.e. a video image of an object) incident on a CCD/CMOS 812. The CCD/CMOS 812 is an image sensor using a CCD or a CMOS. The CCD/CMOS 812 converts the intensity of the received light into an electrical signal, and supplies the electrical signal to a camera signal processing unit 813.

The camera signal processing unit 813 transforms the electrical signal supplied from the CCD/CMOS 812 into a YCrCb chrominance signal, and supplies the signal to an image signal processing unit 814. Under the control of a controller 821, the image signal processing unit 814 performs predetermined image processing on the image signal supplied from the camera signal processing unit 813, and causes the encoder 841 to encode the image signal by an MPEG method, for example. The image signal processing unit 814 supplies the encoded data generated by encoding the image signal to a decoder 815. The image signal processing unit 814 further obtains display data generated at an on-screen display (OSD) 820, and supplies the display data to the decoder 815.

In the above operation, the camera signal processing unit 813 uses, where appropriate, a DRAM (Dynamic Random Access Memory) 818 connected thereto via a bus 817, to store the image data and the encoded data or the like generated by encoding the image data into the DRAM 818 where necessary.

The decoder 815 decodes the encoded data supplied from the image signal processing unit 814, and supplies the resultant image data (decoded image data) to the LCD 816. The decoder 815 also supplies the display data supplied from the image signal processing unit 814 to the LCD 816. The LCD 816 combines the image corresponding to the decoded image data supplied from the decoder 815 with the image corresponding to the display data, and displays the combined image, where appropriate.

Under the control of the controller 821, the on-screen display 820 outputs the display data of a menu screen formed with symbols, characters, and figures, and icons, to the image signal processing unit 814 via the bus 817.

Based on a signal indicating contents designated by a user using an operation unit 822, the controller 821 performs various kinds of operations, and controls, via the bus 817, the image signal processing unit 814, the DRAM 818, an external interface 819, the on-screen display 820, a media drive 823, and the like. A flash ROM 824 stores programs, data, and the like necessary for the controller 821 to perform various kinds of operations.

For example, in place of the image signal processing unit 814 and the decoder 815, the controller 821 can encode the image data stored in the DRAM 818, and decode the encoded data stored in the DRAM 818. In doing so, the controller 821 may perform encoding and decoding operations by using the same methods as the encoding and decoding methods used by the image signal processing unit 814 and the decoder 815, or may perform encoding and decoding operations by using methods that are not compatible with the image signal processing unit 814 and the decoder 815.

When a start of image printing is requested through the operation unit 822, for example, the controller 821 reads image data from the DRAM 818, and supplies the image data to a printer 834 connected to the external interface 819 via the bus 817, so that the printing is performed.

Further, when image recording is requested through the operation unit 822, for example, the controller 821 reads encoded data from the DRAM 818, and supplies and stores the encoded data into the recording medium 833 mounted on the media drive 823 via the bus 817.

The recording medium 833 is a readable and writable removable medium, such as a magnetic disk, a magnetooptical disk, an optical disk, or a semiconductor memory. The recording medium 833 may be any kind of removable medium, and may be a tape device, a disk, or a memory card. It is of course possible to use a non-contact IC card or the like.

Alternatively, the media drive 823 and the recording medium 833 may be integrated, and may be formed with an immobile storage medium such as an internal hard disk drive or an SSD (Solid State Drive).

The external interface 819 is formed with a USB input/output terminal and the like, for example, and is connected to the printer 834 when image printing is performed. Also, a drive 831 is connected to the external interface 819 where necessary, and a removable medium 832 such as a magnetic disk, an optical disk, or a magnetooptical disk is mounted on the drive 831 where appropriate. A computer program that is read from such a disk is installed in the flash ROM 824 where necessary.

Further, the external interface 819 includes a network interface connected to a predetermined network such as a LAN or the Internet. In accordance with an instruction from the operation unit 822, for example, the controller 821 can read encoded data from the DRAM 818, and supply the encoded data from the external interface 819 to another device connected thereto via a network. Also, the controller 821 can obtain, via the external interface 819, encoded data and image data supplied from another device via a network, and store the data into the DRAM 818 or supply the data to the image signal processing unit 814.

The above described camera 800 uses the decoding device 100 as the decoder 815. Therefore, as in the case of the decoding device 100, when a motion compensation operation with fractional precision is performed upon inter prediction, the decoder 815 can decode an image encoded so as to improve encoding efficiency.

The camera 800 also uses the encoding device 10 as the encoder 841. Therefore, as in the case of the encoding device 10, the encoder 841 can improve encoding efficiency when a motion compensation operation with fractional precision is performed upon inter prediction, while suppressing a degradation in the precision of inter prediction.

The decoding method used by the decoding device 100 may be applied to decoding operations to be performed by the controller 821. Likewise, the encoding method used by the encoding device 10 may be applied to encoding operations to be performed by the controller 821.

Image data to be captured by the camera 800 may be of a moving image, or may be of a still image.

It is of course possible to apply the encoding device 10 and the decoding device 100 to any devices and systems other than the above described devices.

It should be noted that embodiments of the present technique are not limited to the above described embodiment, and various modifications may be made to it without departing from the scope of the present technique.

The present technique may also be embodied in the structures described below.

(1)

A decoding device including: a reception unit that receives an encoded image, a difference between a motion vector of the image in an inter prediction and a predicted vector, and detected-precision information indicating that precision of the motion vector for when a prediction direction of the inter prediction is bidirectional is lower than precision of the motion vector for when the prediction direction is unidirectional, the predicted vector being a motion vector of an image located close to the image; a predicted-vector transform unit that performs, when the precision of the motion vector is lower than the predetermined precision and the precision of the predicted vector is the predetermined precision according to the detected-precision information received by the reception unit, a rounding operation on the predicted vector to generate a predicted vector with a lower precision than the predetermined precision; a motion vector generation unit that adds the predicted vector with a lower precision than the predetermined precision generated by the predicted-vector transform unit to the difference received by the reception unit, to generate a motion vector; and a decoding unit that decodes the image by performing a motion compensation operation using the motion vector generated by the motion vector generation unit.

(2)

In the decoding device described in the above described (1),

when the prediction direction of the inter prediction is unidirectional and a size of a prediction block in the inter prediction is large, the motion vector is detected with the predetermined precision, and when the prediction direction of the inter prediction is bidirectional or the size of the prediction block is small, the motion vector is detected with a lower precision than the predetermined precision.

(3)

A decoding method performed by a decoding device and including: a reception step of receiving an encoded image, a difference between a motion vector of the image in an inter prediction and a predicted vector, and detected-precision information indicating that precision of the motion vector for when a prediction direction of the inter prediction is bidirectional is lower than precision of the motion vector for when the prediction direction is unidirectional, the predicted vector being a motion vector of an image located close to the image; a predicted-vector transform step of performing, when the precision of the motion vector is lower than the predetermined precision and the precision of the predicted vector is the predetermined precision according to the detected-precision information received in the operation of the reception step, a rounding operation on the predicted vector to generate a predicted vector with a lower precision than the predetermined precision; a motion vector generation step of adding the predicted vector with a lower precision than the predetermined precision generated in the operation of the predicted-vector transform step to the difference received in the operation of the reception step, to generate a motion vector; and

a decoding step of decoding the image by performing a motion compensation operation using the motion vector generated in the operation of the motion vector generation step.

(4)

An encoding device including: a high-precision motion detection unit that detects, with a predetermined precision, when a prediction direction of an inter prediction of an encoding target image is unidirectional, the motion vector of a reference image for the encoding target image in the inter prediction, using the encoding target image and the reference image for the encoding target image; a low-precision motion detection unit that detects, with a lower precision than the predetermined precision, the motion vector using the encoding target image and the reference image, when the prediction direction is bidirectional; an encoding unit that encodes the encoding target image by performing a motion compensation operation using the motion vector detected by the high-precision motion detection unit or the low-precision motion detection unit; and a transmission unit that transmits the encoding target image encoded by the encoding unit, and the motion vector.

(5)

In the encoding device described in the above described (4),

when the prediction direction of the inter prediction is unidirectional and a size of a prediction block in the inter prediction is large, the high-precision motion detection unit detects the motion vector with the predetermined precision, and

when the prediction direction of the inter prediction is bidirectional or the size of the prediction block is small, the low-precision motion detection unit detects the motion vector with a lower precision than the predetermined precision.

(6)

In the encoding device described in the above described (4),

the transmission unit transmits detected-precision information indicating that precision of the motion vector for when the prediction direction of the inter prediction is bidirectional is lower than precision of the motion vector for when the prediction direction of the inter prediction is unidirectional.

(7)

In the encoding device described in any one of the above described (4) to (6),

the transmission unit transmits a difference between the motion vector detected by the high-precision motion detection unit or the low-precision motion detection unit and a predicted vector, the predicted vector being a motion vector of an image located close to the encoding target image.

(8)

The encoding device described in the above described (7) further includes:

a predicted-vector transform unit that performs, when the motion vector is detected with a lower precision than the predetermined precision and the predicted vector is detected with the predetermined precision, a rounding operation on the predicted vector to generate a predicted vector with a lower precision than the predetermined precision, and

the transmission unit transmits a difference between the motion vector and the predicted vector with a lower precision than the predetermined precision.

(9)

An encoding method performed by an encoding device and including: a high-precision motion detection step of detecting, with a predetermined precision, when a prediction direction of an inter prediction of an encoding target image is unidirectional, the motion vector of a reference image for the encoding target image in the inter prediction, using the encoding target image and the reference image for the encoding target image; a low-precision motion detection step of detecting, with a lower precision than the predetermined precision, the motion vector using the encoding target image and the reference image, when the prediction direction is bidirectional; an encoding step of encoding the encoding target image by performing a motion compensation operation using the motion vector detected in the operation of the high-precision motion detection step or the low-precision motion detection step; and a transmission step of transmitting the encoding target image encoded by the operation of the encoding step, and the motion vector.

### REFERENCE SIGNS LIST

10 Encoding Device
13 Arithmetic Operation Unit
17 Accumulation Buffer
24 Inter Prediction Unit
41 L0 Motion Detection Unit
42 L1 Motion Detection Unit
43 Bidirectional Motion Detection Unit
100 Decoding Device
101 Accumulation Buffer
105 Addition Unit
111 Predicted-vector Transform Unit
112 Motion Vector Generation Unit

1. A decoding device comprising:
a reception unit that receives an encoded image, a difference between a motion vector of the image in an inter prediction and a predicted vector, and detected-precision information indicating that precision of the motion vector for when a prediction direction of the inter prediction is bidirectional is lower than precision of the motion vector for when the prediction direction is unidirectional, the predicted vector being a motion vector of an image located close to the image;
a predicted-vector transform unit that performs, when the precision of the motion vector is lower than the predetermined precision and the precision of the predicted vector is the predetermined precision according to the detected-precision information received by the reception unit, a rounding operation on the predicted vector to generate a predicted vector with a lower precision than the predetermined precision;
a motion vector generation unit that adds the predicted vector with a lower precision than the predetermined precision generated by the predicted-vector transform unit to the difference received by the reception unit, to generate a motion vector; and
a decoding unit that decodes the image by performing a motion compensation operation using the motion vector generated by the motion vector generation unit.

2. The decoding device according to claim 1, wherein
when the prediction direction of the inter prediction is unidirectional and a size of a prediction block in the inter prediction is large, the motion vector is detected with the predetermined precision, and when the prediction direction of the inter prediction is bidirectional or the size of the prediction block is small, the motion vector is detected with a lower precision than the predetermined precision.

3. A decoding method performed by a decoding device and comprising:
a reception step of receiving an encoded image, a difference between a motion vector of the image in an inter prediction and a predicted vector, and detected-precision information indicating that precision of the motion vector for when a prediction direction of the inter prediction is bidirectional is lower than precision of the motion vector for when the prediction direction is unidirectional, the predicted vector being a motion vector of an image located close to the image;
a predicted-vector transform step of performing, when the precision of the motion vector is lower than the predetermined precision and the precision of the predicted vector is the predetermined precision according to the detected-precision information received in the operation of the reception step, a rounding operation on the predicted vector to generate a predicted vector with a lower precision than the predetermined precision;
a motion vector generation step of adding the predicted vector with a lower precision than the predetermined precision generated in the operation of the predicted-vector transform step to the difference received in the operation of the reception step, to generate a motion vector; and
a decoding step of decoding the image by performing a motion compensation operation using the motion vector generated in the operation of the motion vector generation step.

4. An encoding device comprising:
a high-precision motion detection unit that detects, with a predetermined precision, when a prediction direction of an inter prediction of an encoding target image is unidirectional, the motion vector of a reference image for the encoding target image in the inter prediction, using the encoding target image and the reference image for the encoding target image;
a low-precision motion detection unit that detects, with a lower precision than the predetermined precision, the motion vector using the encoding target image and the reference image, when the prediction direction is bidirectional;
an encoding unit that encodes the encoding target image by performing a motion compensation operation using the motion vector detected by the high-precision motion detection unit or the low-precision motion detection unit; and
a transmission unit that transmits the encoding target image encoded by the encoding unit, and the motion vector.

5. The encoding device according to claim 4, wherein
when the prediction direction of the inter prediction is unidirectional and a size of a prediction block in the inter prediction is large, the high-precision motion detection unit detects the motion vector with the predetermined precision, and
when the prediction direction of the inter prediction is bidirectional or the size of the prediction block is small, the low-precision motion detection unit detects the motion vector with a lower precision than the predetermined precision.

6. The encoding device according to claim 4, wherein
the transmission unit transmits detected-precision information indicating that precision of the motion vector for when the prediction direction of the inter prediction is bidirectional is lower than precision of the motion vector for when the prediction direction of the inter prediction is unidirectional.

7. The encoding device according to claim 4, wherein
the transmission unit transmits a difference between the motion vector detected by the high-precision motion detection unit or the low-precision motion detection unit and a predicted vector, the predicted vector being a motion vector of an image located close to the encoding target image.

8. The encoding device according to claim 7, further comprising:
a predicted-vector transform unit that performs, when the motion vector is detected with a lower precision than the predetermined precision and the predicted vector is detected with the predetermined precision, a rounding operation on the predicted vector to generate a predicted vector with a lower precision than the predetermined precision, wherein
the transmission unit transmits a difference between the motion vector and the predicted vector with a lower precision than the predetermined precision.

9. An encoding method performed by an encoding device and comprising:
a high-precision motion detection step of detecting, with a predetermined precision, when a prediction direction of an inter prediction of an encoding target image is unidirectional, the motion vector of a reference image for the encoding target image in the inter prediction, using the encoding target image and the reference image for the encoding target image;
a low-precision motion detection step of detecting, with a lower precision than the predetermined precision, the motion vector using the encoding target image and the reference image, when the prediction direction is bidirectional;
an encoding step of encoding the encoding target image by performing a motion compensation operation using the motion vector detected in the operation of the high-precision motion detection step or the low-precision motion detection step; and
a transmission step of transmitting the encoding target image encoded in the operation of the encoding step, and the motion vector.
